(19) United States
(12) Patent Application Publication
(10) Pub. No.: US 2013/0334962 A1
(43) Pub. Date: Dec. 19, 2013

(54) DISCHARGE LAMP LIGHTING DEVICE, AUTOMOTIVE HIGH-INTENSITY DISCHARGE LAMP LIGHTING DEVICE, AUTOMOTIVE HEADLIGHT DEVICE, AND CAR

(71) Applicant: Panasonic Corporation, Osaka (JP)

(72) Inventor: Masahiro NISHIKAWA, Niigata (JP)

(73) Assignee: Panasonic Corporation, Osaka (JP)

(21) Appl. No.: 13/904,172

(22) Filed: May 29, 2013

(30) Foreign Application Priority Data
Jun. 1, 2012 (JP) 2012-126105

(51) Int. Cl. H05B 41/14; B60Q 1/00

(52) U.S. Cl. CPC H05B 41/14; B60Q 1/00
USPC 315/82; 315/268; 315/77

(57) ABSTRACT

The discharge lamp lighting device in accordance with the present invention includes a controller configured to perform an abnormality judgment process of judging whether or not abnormality has occurred based on a measured value of a driving voltage defined as an AC voltage applied to a discharge lamp. The controller is configured to, in the abnormality judgment process, judge whether or not an asymmetric state in which the driving voltage lacks symmetry has occurred over a predetermined period. The controller is configured to, upon concluding that the asymmetric state has occurred over the predetermined period, conclude that the abnormality has occurred.

### TECHNICAL FIELD

The present invention relates to discharge lamp lighting devices, automotive high-intensity discharge lamp lighting devices, automotive headlight devices, and cars.

### BACKGROUND ART

Since a high-intensity discharge lamp (e.g., a metal halide lamp) has a relatively high luminance, such a high-intensity discharge lamp is used in a vehicle (car) such as an automobile, a motorcycle, and a train.

FIG. 18 shows an instance of a circuit configuration of a prior discharge lamp lighting device “B” configured to light a high-intensity discharge lamp. The discharge lamp lighting device “B” includes a DC/DC converter 101, a detector 102, an inverter 103, an igniter 104, a power supply voltage detector 105, a temperature detector 106, a controller 107, and drivers 108 and 109.

The DC/DC converter 101 functions as a power converter configured to increase or decrease a DC voltage (power supply voltage) of a DC power source E101 to output desired DC power. For example, the DC/DC converter 101 is a flyback converter circuit. Interposed between the DC power source E101 and the DC/DC converter 101 is a switch SW101. Further, the discharge lamp lighting device “B” is activated or deactivated according as the switch SW101 is turned on or off. Furthermore, a low-voltage line of the DC power source E101 is connected to a circuit ground.

The detector 102 includes a voltage detector 102a and a current detector 102b. The voltage detector 102a is constituted by a series circuit of resistors R101, R102, and R103 having one end connected to an output terminal of the DC/DC converter 101 and the other end connected to the controller 107. The current detector 102b is constituted by a resistor R104 interposed between the output terminals of the DC/DC converter 101.

The inverter 103 functions to convert the DC power outputted from the DC/DC converter 101 into AC power and supplies the resultant AC power to the discharge lamp La. For example, the inverter 103 is constituted by switching elements connected in a full-bridge manner.

The igniter 104 generates a high voltage of tens kV for starting the discharge lamp La.

The power supply voltage detector 105 detects the input voltage (power supply voltage) of the DC/DC converter 101.

The temperature detector 106 detects an ambient temperature of the discharge lamp lighting device “B”.

The controller 107 performs a feed-back control with regard to the output of the DC/DC converter 101 such that the lamp power is kept identical to a power target value.

Specifically, the controller 107 detects the output voltage Vo101 of the DC/DC converter 101 by use of the voltage detector 102a, thereby equivalently detecting a lamp voltage applied to the discharge lamp La. Further, the controller 107 detects the output current Io101 of the DC/DC converter 101 by use of the current detector 102b, thereby equivalently detecting a lamp current supplied to the discharge lamp La.

Moreover, the controller 107 creates the power target value adjusted in accordance with the power supply voltage detected by the power supply voltage detector 105 and the ambient temperature detected by the temperature detector 106. The controller 107 calculates a current target value by dividing the resultant power target value by a detection value of the output voltage Vo101. The controller 107 compares the detection value of the output current Io101 with the current target value and outputs an error signal having a magnitude corresponding to a difference therebetween to the driver 108.

The driver 108 outputs a driving signal to the DC/DC converter 101 based on the error signal such that the detection value of the output current Io101 is identical to the current target value.

Moreover, the controller 107 outputs a control signal for controlling the inverter 103 to the driver 109. The driver 109 outputs a driving signal to the inverter 103 based on the control signal.

The controller 107 controls the operations of the DC/DC converter 101 and the inverter 103 through the aforementioned operation to light the discharge lamp La.

In this discharge lamp lighting device “B”, when a short circuit or a ground fault occurs on a side of the discharge lamp La (load side), a ground fault current may cause an increase in a loss of circuits or a stress of components. As a result, circuit breakage may occur.

In this regard, when a short circuit or a ground fault occurs on the load side, the output voltage Vo101 tends to be decreased. In view of this, the controller 107 terminates the operation of the DC/DC converter 101 when the output voltage Vo101 is decreased down to a voltage not greater than a threshold (e.g., see document 1 [JP 2006-252872 A).

According to the aforementioned prior art, when a short circuit or a ground fault occurs on the load side, the controller 107 terminates the operation of the DC/DC converter 101.

However, the controller 107 is required to, when a short circuit or a ground fault occurs on the load side, detect an event where the output voltage Vo101 is decreased down to a voltage not greater than the threshold. When a short circuit of the discharge lamp La occurs, impedance of the discharge lamp La becomes substantially zero, and the output voltage Vo101 is decreased from its normal level by a significant extent. Hence, it is possible to terminate the operation of the DC/DC converter 101.

In contrast, when a ground fault occurs, as long as impedance between a point of the ground fault and the circuit ground is substantially zero, like the occurrence of a short circuit, the output voltage Vo101 is decreased from its normal level by a significant extent. Hence, it is possible to terminate the operation of the DC/DC converter 101. Note that, hereinafter, the impedance between the point of the ground fault and the circuit ground is referred to as a ground fault resistance.

However, when the ground fault resistance is relatively high, the output voltage Vo101 is unlikely to be decreased down to a voltage not greater than the threshold. In this case, although a ground fault occurs on the load side, the controller 107 fails to terminate the operation of the DC/DC converter 101. As a result, the DC/DC converter 101 is likely to continue the output operation despite the occurrence of the ground fault. Consequently, a current higher than that in the steady lighting state continues to flow. Thus, such a high current causes an increase in a loss of circuits or a stress of components. As a result, circuit breakage may occur.

### SUMMARY OF INVENTION

In view of the above insufficiency, the present invention has aimed to propose a discharge lamp lighting device, an automotive (in-car) high-intensity discharge lamp lighting device, an automotive (in-car) headlight device, and a car which are capable of detecting a ground fault even when such a ground fault occurs with a relatively high ground-fault resistance.

The discharge lamp lighting device of the first aspect in accordance with the present invention includes a controller configured to perform an abnormality judgment process of judging whether or not abnormality has occurred based on a measured value of a driving voltage defined as an AC voltage applied to a discharge lamp. The controller is configured to, in the abnormality judgment process, judge whether or not an asymmetric state in which the driving voltage lacks symmetry has occurred over a predetermined period. The controller is configured to, upon concluding that the asymmetric state has occurred over the predetermined period, conclude that the abnormality has occurred.

As for the discharge lamp lighting device of the second aspect in accordance with the present invention, in addition to the first aspect, the controller is configured to, upon acknowledging that an absolute value of one of a first measured value defined as the measured value obtained before a reversal of polarity of the driving voltage and a second measured value defined as the measured value obtained after the reversal of polarity of the driving voltage is greater than an absolute value of the other of the first measured value and the second measured value, conclude that the asymmetric state has occurred.

As for the discharge lamp lighting device of the third aspect in accordance with the present invention, in addition to the second aspect, the controller is configured to calculate a proportion of a larger one of the absolute values of the respective first and second measured values to a smaller one of the absolute values of the respective first and second measured values; and, upon acknowledging that the proportion is not less than a threshold, conclude that the asymmetric state has occurred.

As for the discharge lamp lighting device of the fourth aspect in accordance with the present invention, in addition to the third aspect, the threshold is not less than 1.5.

As for the discharge lamp lighting device of the fifth aspect in accordance with the present invention, in addition to the second aspect, the controller is configured to calculate a difference between the absolute values of the respective first and second measured values; and, upon acknowledging that an absolute value of the difference is not less than a threshold, conclude that the asymmetric state has occurred.

As for the discharge lamp lighting device of the sixth aspect in accordance with the present invention, in addition to the fifth aspect, the threshold is not less than one-half of a rated lamp voltage of the discharge lamp.

As for the discharge lamp lighting device of the seventh aspect in accordance with the present invention, in addition to the first to sixth aspects, the controller is configured to, upon acknowledging that the asymmetric state continues for the predetermined period, conclude that the asymmetric state has occurred over the predetermined period.

As for the discharge lamp lighting device of the eighth aspect in accordance with the present invention, in addition to the seventh aspect, the predetermined period has a length equal to that of a start-up period of the discharge lamp.

As for the discharge lamp lighting device of the ninth aspect in accordance with the present invention, in addition to the seventh or eighth aspect, the predetermined period has a length not less than 10 seconds.

As for the discharge lamp lighting device of the tenth aspect in accordance with the present invention, in addition to any one of the first to ninth aspects, the controller is configured to, upon acknowledging that the number of times of occurrence of the asymmetric state is not less than a predetermined number of times before a passage of a prescribed period, conclude that the asymmetric state has occurred over the predetermined period.

As for the discharge lamp lighting device of the eleventh aspect in accordance with the present invention, in addition to any one of the first to tenth aspects, the discharge lamp lighting device further includes a lighting circuit unit having a function of applying an AC voltage to the discharge lamp. The controller is configured to control the lighting circuit unit to adjust power supplied to the discharge lamp.

As for the discharge lamp lighting device of the twelfth aspect in accordance with the present invention, in addition to the eleventh aspect, the lighting circuit unit includes a power converter, an inverter, a voltage detector, and a current detector. The power converter is configured to generate DC power by use of power from an external power source. The inverter is configured to apply an AC voltage to the discharge lamp by use of the DC power generated by the power converter. The voltage detector configured to measure a voltage applied to the discharge lamp. The current detector configured to measure a current flowing through the discharge lamp. The controller is configured to adjust the DC power generated by the power converter based on a measured value of the voltage detector and a measured value of the current detector.

As for the discharge lamp lighting device of the thirteenth aspect in accordance with the present invention, in addition to the eleventh or twelfth aspect, the controller is configured to, upon concluding that the abnormality has occurred, decrease power supplied to the discharge lamp down to a predetermined value.

As for the discharge lamp lighting device of the fourteenth aspect in accordance with the present invention, in addition to the thirteenth aspect, the controller is configured to gradually decrease power supplied to the discharge lamp.

As for the discharge lamp lighting device of the fifteenth aspect in accordance with the present invention, in addition to the eleventh or twelfth aspect, the lighting circuit unit has a function of applying a DC voltage to the discharge lamp. The controller is configured to, upon concluding that the abnormality has occurred, control the lighting circuit unit in such a manner to supply to the discharge lamp a DC voltage having the same polarity as that corresponding to larger one of the absolute values of the respective first and second measured values.

As for the discharge lamp lighting device of the sixteenth aspect in accordance with the present invention, in addition to any one of the first to fifteenth aspects, the controller is configured to start the abnormality judgment process after the discharge lamp is changed from a state in the start-up period to a state in a steady lighting period.

The automotive high-intensity discharge lamp lighting device of the seventeenth aspect in accordance with the present invention is defined by the discharge lamp lighting device according to any one of the first to sixteenth aspects, and is configured to light a high-intensity discharge lamp.

The automotive headlight device of the eighteenth aspect in accordance with the present invention includes a discharge lamp, and the discharge lamp lighting device according to any one of the first to sixteenth aspects. The discharge lamp lighting device is configured to light the discharge lamp.

The car of the nineteenth aspect in accordance with the present invention includes the automotive headlight device according to the eighteenth aspect.

### BRIEF DESCRIPTION OF THE DRAWINGS

FIG. 1 is a circuit diagram illustrating a configuration of a discharge lamp lighting device of the first embodiment,

FIG. 2 is a waveform chart illustrating an operation of reading a lamp voltage detection value of the discharge lamp lighting device of the first embodiment,

FIG. 3 is a waveform chart illustrating an operation in a normal state of the discharge lamp lighting device of the first embodiment,

FIG. 4 is a waveform chart illustrating an operation in a ground fault state of the discharge lamp lighting device of the first embodiment,

FIG. 5 is a waveform chart illustrating an operation in the ground fault state of the discharge lamp lighting device of the first embodiment,

FIG. 6 is a waveform chart illustrating an operation in the ground fault state of the discharge lamp lighting device of the first embodiment,

FIG. 7 is a waveform chart illustrating an operation in the ground fault state of the discharge lamp lighting device of the first embodiment,

FIG. 8 is a waveform chart illustrating an operation in the ground fault state of the discharge lamp lighting device of the first embodiment,

FIG. 9 is a graph illustrating a power target value of the discharge lamp lighting device of the first embodiment,

FIG. 10 is a waveform chart illustrating an operation in the ground fault state of the discharge lamp lighting device of the first embodiment,

FIG. 11 is a waveform chart illustrating an operation in the ground fault state of the discharge lamp lighting device of the first embodiment,

FIG. 12 is a waveform chart illustrating an operation in the ground fault state of the discharge lamp lighting device of the second embodiment,

FIG. 13 is a waveform chart illustrating an operation in the ground fault state of the discharge lamp lighting device of the second embodiment,

FIG. 14 is a waveform chart illustrating an operation in the ground fault state of the discharge lamp lighting device of the second embodiment,

FIG. 15 is a waveform chart illustrating an operation in the ground fault state of the discharge lamp lighting device of the third embodiment,

FIG. 16 is a waveform chart illustrating an operation in the ground fault state of the discharge lamp lighting device of the fourth embodiment,

FIG. 17 is a schematic view illustrating a car of the fifth embodiment, and

FIG. 18 is a block diagram illustrating a configuration of a prior discharge lamp lighting device.

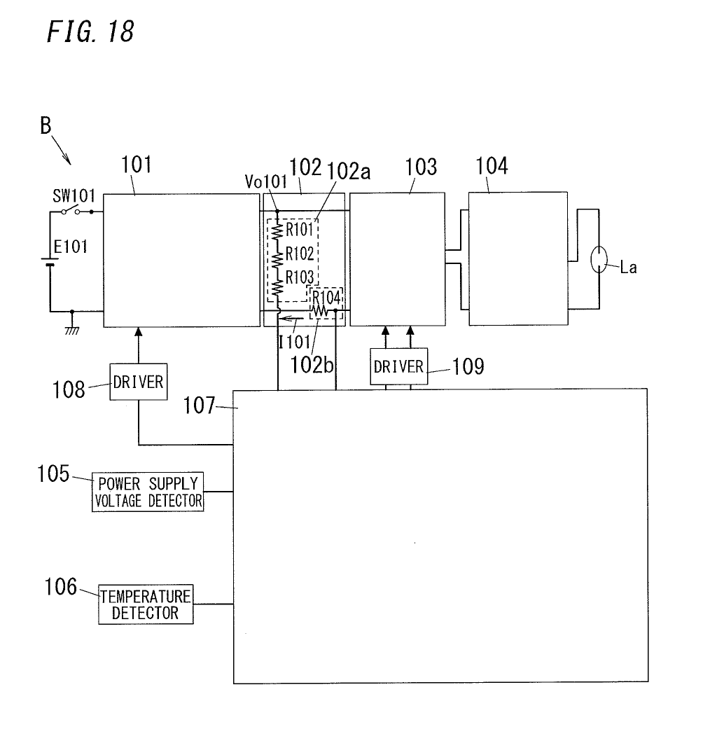

### DESCRIPTION OF EMBODIMENTS

### First Embodiment

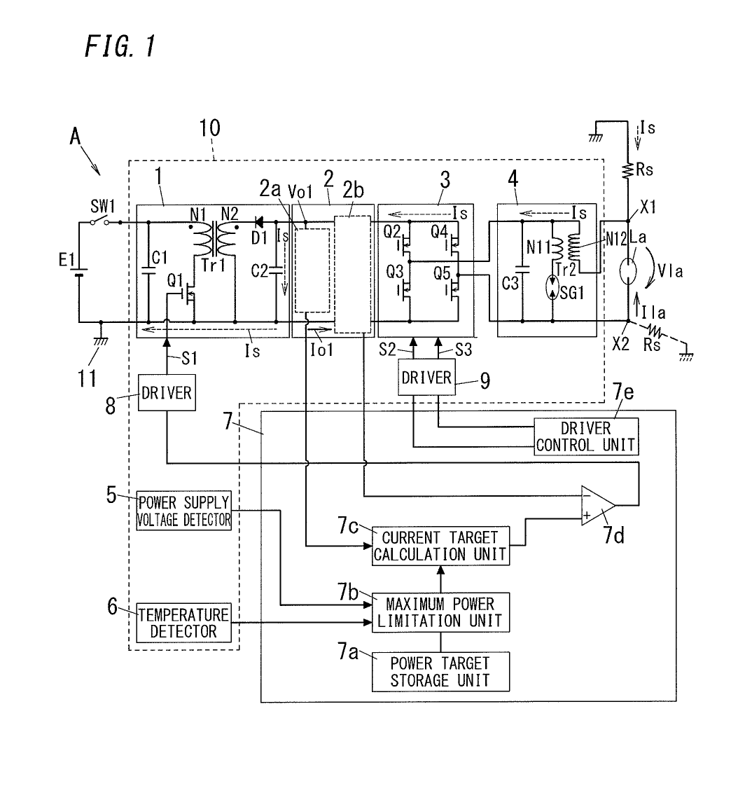

As shown in FIG. 1, the discharge lamp lighting device “A” of the present embodiment includes a lighting circuit unit 10 configured to supply power to a discharge lamp La, and a controller 7 configured to control the lighting circuit unit 10 in such a manner to adjust power supplied to the discharge lamp La.

The lighting circuit unit 10 has a function of applying a driving voltage defined as an AC voltage to the discharge lamp La. For example, the driving voltage is an AC voltage having symmetry. In the present embodiment, the driving voltage is a rectangular AC voltage with symmetry.

For example, the lighting circuit unit 10 in the present embodiment includes a DC/DC converter 1, a detector 2, an inverter 3, an igniter 4, a power supply voltage detector 5, a temperature detector 6, and drivers 8 and 9.

The following detailed explanation is made to the discharge lamp lighting device “A” of the present embodiment. FIG. 1 shows a circuit configuration of the discharge lamp lighting device “A” of the present embodiment configured to light the high-intensity discharge lamp (discharge lamp) La. The discharge lamp lighting device “A” includes the DC/DC converter 1, the detector 2, the inverter 3, the igniter 4, the power supply voltage detector 5, the temperature detector 6, the controller 7, and the drivers 8 and 9. This discharge lamp lighting device “A” is used in a car (vehicle) such as an automobile, a motorcycle, and a train.

The DC/DC converter 1 functions as a power converter configured to increase or decrease a DC voltage (power supply voltage) of a DC power source (external power source) E1 to output desired DC power. In brief, the DC/DC converter 1 serves as a power converter configured to generate DC power by use of power from an external power source (in the present embodiment, the DC power source E1). Note that, for example, the DC power source E1 is an automotive battery (in-vehicle battery). However, the DC power source E1 is not limited to an automotive battery. Besides, the external power source is not limited to a DC power source but may be an AC power source. In this case, an AC/DC converter is used as a power converter.

As shown in FIG. 1, the DC/DC converter 1 is a flyback converter circuit using a transformer Tr1. There is a series circuit of a switch SW1, a primary winding N1 of the transformer Tr1, and a switching element Q1 interposed between input terminals of the DC/DC converter 1. Further, there is a capacitor C1 also interposed between the input terminals of the DC/DC converter 1. There is a series circuit of a diode D1 and a capacitor C2 interposed between opposite ends of a secondary winding N2 of the transformer Tr1.

Turning on and off the switching element Q1 causes an increase or decrease in the DC voltage (power supply voltage) from the DC power source E1 to develop a DC voltage across the capacitor C2. In brief, the DC/DC converter 1 converts input from the DC power source E1 into a desired DC power. Further, the discharge lamp lighting device “A” is activated or deactivated according as the switch SW1 is turned on or off. Furthermore, a low-voltage line of the DC power source E1 is connected to a circuit ground 11.

The detector 2 includes a voltage detector 2a and a current detector 2b.

The voltage detector 2a detects an output voltage Vo1 of the DC/DC converter 1, thereby equivalently detecting a lamp voltage Vla applied to the discharge lamp La mentioned below. In other words, the voltage detector 2a is configured to measure the voltage (lamp voltage) Vla applied to the discharge lamp La. For example, this voltage detector 2a is constituted by a series circuit of one or more resistors having one end connected to an output terminal of the DC/DC converter 1 and the other end connected to the controller 7.

Further, the current detector 2b detects an output current Io1 of the DC/DC converter 1, thereby equivalently detecting a lamp current Ila supplied to the discharge lamp La. In other words, the current detector 2b is configured to measure the current (lamp current) Ila flowing through the discharge lamp La. For example, this current detector 2b is constituted by a resistor interposed between the output terminals of the DC/DC converter 1 and is configured to detect a voltage across this resistor.

In the following explanation, if necessary, a detection value of the output voltage Vo1 (a measured value of the voltage detector 2a) is referred to as a lamp voltage detection value, and a detection value of the output current Io1 (a measured value of the current detector 2b) is referred to as a lamp current detection value.

The inverter (inverter circuit) 3 is connected to the output terminal of the DC/DC converter 1 via the detector 2, and is constituted by switching elements Q2 to Q5 connected in a full-bridge manner. A series circuit of the switching elements Q2 and Q3 and a series circuit of the switching elements Q4 and Q5 are connected in parallel with each other between the output terminals of the DC/DC converter 1.

With turning on and off alternately a set of the switching elements Q2 and Q5 and a set of the switching elements Q3 and Q4, a rectangular AC voltage alternating at a low frequency is developed between a connection point of the switching elements Q2 and Q3 and a connection point of the switching elements Q4 and Q5.

In brief, the inverter circuit 3 converts the DC power outputted from the DC/DC converter 1 into AC power and supplies the resultant AC power to the discharge lamp La. In this regard, the inverter 3 is configured to apply the AC voltage (driving voltage) to the discharge lamp La by use of the DC power generated by the DC/DC converter (power converter) 1. The AC voltage outputted from the inverter 3 is a symmetric rectangular AC voltage. Therefore, in the AC voltage outputted from the inverter 3, a voltage at positive polarity and a voltage at negative polarity have the same magnitude (absolute value).

Note that, preferably, a frequency of the AC voltage is in a range of 200 Hz to 600 Hz.

The igniter 4 is constituted by a capacitor C3, a transformer Tr2, and a spark gap SG1, and generates a high voltage of tens kV for starting the discharge lamp La. The capacitor C3 is connected between output terminals of the inverter 3. The transformer Tr2 has a primary winding N11 and a secondary winding N12 which are connected to each other at their first ends. The primary winding N11 has a second end connected to the spark gap SG1. A series circuit of the primary winding N11 and the spark gap SG1 is connected in parallel with the capacitor C3. Further, the discharge lamp La is connected between a second end of the secondary winding N12 and a connection point of the spark gap SG1 and the capacitor C3.

The power supply voltage detector 5 detects the input voltage (power supply voltage) of the DC/DC converter 1.

The temperature detector 6 detects an ambient temperature of the discharge lamp lighting device “A”.

The controller 7 includes a power target storage unit 7a, a maximum power limitation unit 7b, a current target calculation unit 7c, an error amplifier 7d, and a driver control unit 7e. The controller 7 is constructed by use of a microcomputer, for example.

The power target storage unit 7a preliminarily stores a target value (initial power target value) of the lamp power supplied to the discharge lamp La. This initial power target value is defined as a value in a situation where the ambient temperature and the power supply voltage are identical to respective reference values.

The maximum power limitation unit 7b adjusts the initial power target value retrieved from the power target storage unit 7a based on the power supply voltage detected by the power supply voltage detector 5 and the ambient temperature detected by the temperature detector 6, thereby creating a power target value. The current target calculation unit 7c calculates a current target value by dividing the power target value obtained from the maximum power limitation unit 7b by the lamp voltage detection value.

The error amplifier 7d compares the lamp current detection value with the current target value and outputs an error signal having a magnitude corresponding to a difference therebetween to the driver 8. To reduce the magnitude of the error signal, the driver 8 outputs a driving signal S1 determining a switching frequency and a duty cycle of the switching element Q1 so as to turn on and off the switching element Q1.

Further, the driver control unit 7e outputs a control signal for switching control of the switching elements Q2 to Q5 to the driver 9.

In response to the control signal, the driver 9 outputs, to the inverter 3, driving signals S2 and S3 to turn on and off the set of the switching elements Q2 and Q5 and the set of the switching elements Q3 and Q4 alternately.

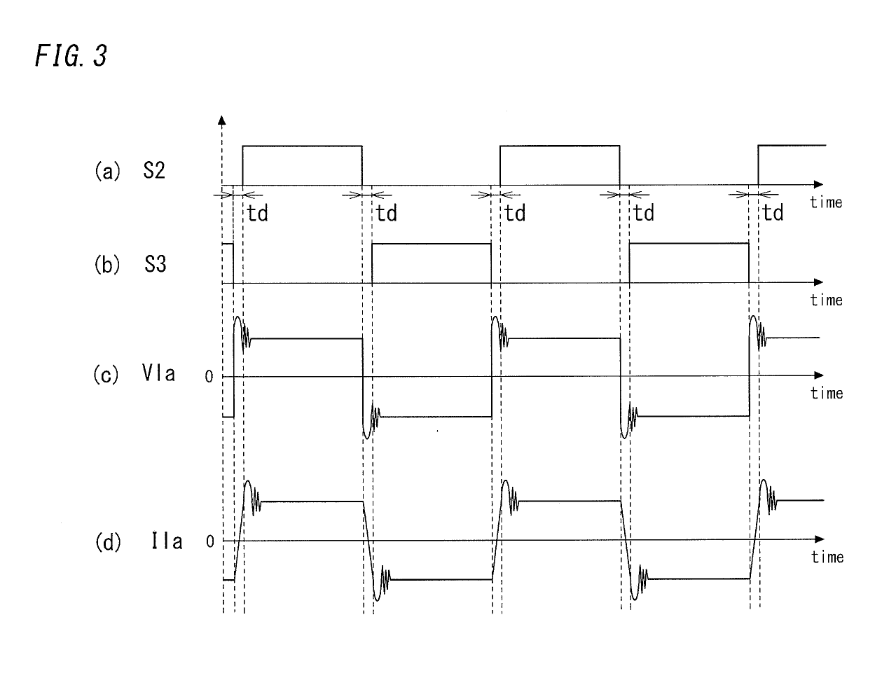

As shown in (a) and (b) of FIG. 3, the driving signal S2 for driving the switching elements Q2 and Q5 and the driving signal S3 for driving the switching elements Q3 and Q4 alternate between an H level and an L level.

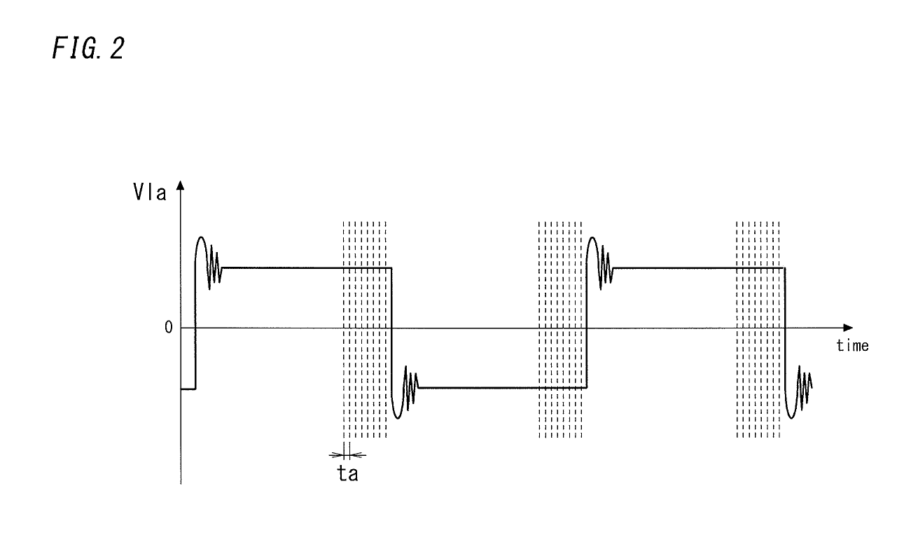

The current target calculation unit 7c reads the lamp voltage detection value at intervals of a period ta, and stores the read value temporarily. As shown in FIG. 2, the lamp voltage Vla developed between the opposite ends of the discharge lamp La has a waveform identical to a waveform obtained by inverting the polarity of the output voltage Vo1 periodically. The current target calculation unit 7c uses an average of the eight lamp voltage detection values obtained immediately before the timing of the reversal of the polarity to calculate the current target value. This manner is selected for the following reason.

The waveforms of the driving signal S2 for driving the switching elements Q2 and Q5 and the driving signal S3 for driving the switching elements Q3 and Q4 are shown in (a) and (b) of FIG. 3, respectively.

With regard to the driving signals S2 and S3, dead time td in which the driving signals S2 and S3 have the L level and all the switching elements Q2 to Q5 are kept turned off is provided. In the dead time td, the lamp current Ila becomes zero instantaneously (see FIG. 3 (d)). Hence, the output voltage Vo1 of the DC/DC converter 1 is increased, and the lamp voltage Vla becomes unstable.

In contrast, immediately before the timing of the reversal of the polarity, the lamp voltage Vla is stable. Thus, as mentioned above, the current target calculation unit 7c uses the average of the eight lamp voltage detection values obtained immediately before the timing of the reversal of the polarity to calculate the current target value. Consequently, an accuracy of the current target value can be improved.

Next, the operation of the discharge lamp lighting device “A” is explained in detail.

First, when the switch SW1 is turned on, the discharge lamp lighting device “A” is activated. Thereafter, when the switching element Q1 is turned on, a current is outputted from the DC power source E1 and flows through the primary winding N1 of the transformer Tr1 and the switching element Q1. In contrast, the inversely-biased diode D1 prevents the current from flowing through the secondary winding N2 of the transformer Tr1. Thus, the transformer Tr1 stores magnetic energy therein. Next, when the switching element Q1 is turned off, a current flows from the secondary winding N2 of the transformer Tr1 to the diode D1 through the capacitor C2, and therefore energy stored in the transformer Tr1 is transferred to the smoothing capacitor C2.

Before the initiation of the discharge lamp La, the discharge lamp La is in an open state. Hence, a voltage across the capacitor C2 is increased. While the switching elements Q2 and Q5 are kept in an on-state and the switching elements Q3 and Q4 are kept in an off-state, a voltage across the capacitor C3 of the igniter 4 is also increased. When the voltage across the capacitor C3 reaches a breakdown voltage, the spark gap SG1 is broken down and a high voltage turn-ratio times as high as the voltage across the primary winding N11 is induced across the secondary winding N12 of the transformer Tr2. Such a high voltage (about tens kV) is applied to the discharge lamp La and then the discharge lamp La is broken down.

In response to breakdown of the discharge lamp La, a current is supplied from the DC/DC converter 1 to the discharge lamp La, and the discharge lamp La causes an arc discharge.

Subsequently, turning on and off the set of the switching elements Q2 and Q5 and the set of the switching elements Q3 and Q4 alternately causes application of an AC voltage to the discharge lamp La. Hence, the discharge lamp La lights steadily. In this regard, as mentioned above, the DC outputted from the DC/DC converter 1 is controlled by the error signal outputted from the error amplifier 7d of the controller 7 and a feed-back control is performed such that the lamp power is kept identical to the target value.

When a short circuit or a ground fault occurs on the discharge lamp La side (load side), the discharge lamp “A” shows the following operation.

When the lamp detection value (see FIG. 2, the average of the eight lamp voltage detection values read immediately before the timing of the reversal of the polarity) is decreased down to a value equal to or less than a predetermined threshold K1, the current target calculation unit 7c of the controller 7 adjusts the current target value to zero, thereby keeping the switching element Q1 in the off-state.

In other words, when a short circuit or a ground fault occurs on the load side and the lamp voltage detection value is decreased by a greater extent than that in a normal state, the controller 7 terminates the operation of the DC/DC converter 1. At this time, also the driver control unit 7e keeps the switching elements Q2 to Q5 in the off-state, thereby terminating the operation of the inverter 3.

This protective function is effective for a case where the discharge lamp La is short-circuited or a ground fault resistance is relatively low. Note that, hereinafter, this protective function is referred to as a first protective function.

However, when the ground fault resistance is relatively high, there is a possibility that the lamp voltage detection value is not decreased down to a value equal to or less than the threshold K1.

For example, as shown in FIG. 1, when a ground fault occurs at a point X1 on the first end of the discharge lamp La and a ground fault resistance Rs is relatively high, a ground fault current Is does not flow through the discharge lamp La. Consequently, extinction of the discharge lamp La occurs.

However, since the lamp voltage detection value is not less than the threshold K1, the aforementioned first protective function does not work.

In view of this, the controller 7 has a second protective function using a limitation on a voltage ratio of the lamp voltage. In the second protective function, the controller 7 is configured to perform an abnormality judgment process of judging whether or not abnormality has occurred based on a measured value of a driving voltage defined as an AC voltage applied to the discharge lamp La. This controller 7 serves as an abnormality detection device. Note that, in the present embodiment, the controller 7 is configured to acquire the measured value of the AC voltage (driving voltage) applied to the discharge lamp La from the voltage detector 2a. In other words, the controller 7 and the voltage detector 2a are considered as constituting the abnormality detection device.

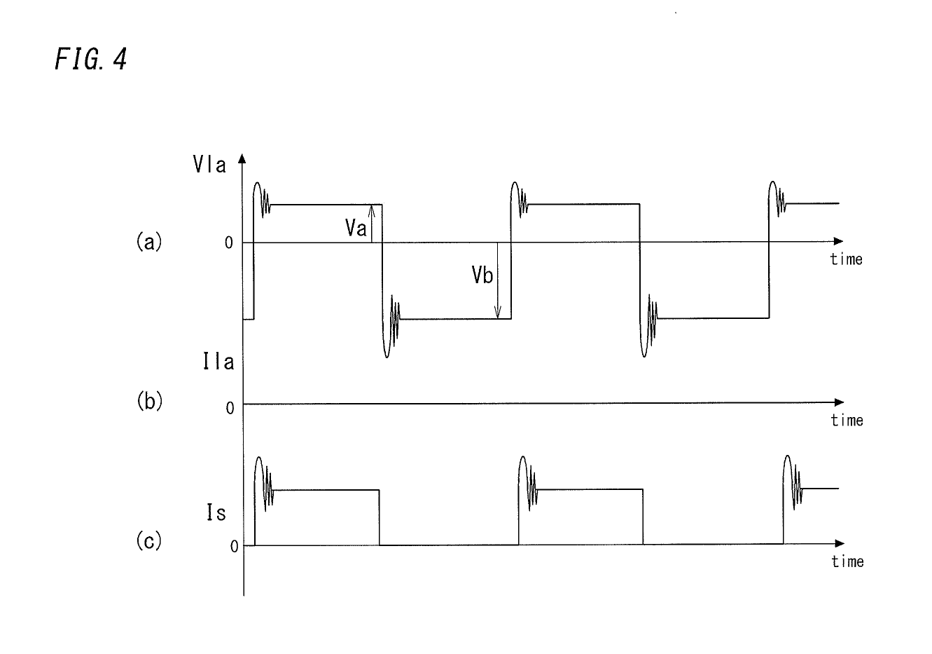

When a ground fault occurs at the point X1 as shown in FIG. 1, waveforms of the lamp voltage Vla, the lamp current Ila, and the ground fault current Is are illustrated in (a) to (c) of FIG. 4, respectively.

The ground current Is flows through an imaginary resistor having the ground fault resistance Rs, the igniter 4, the inverter 3, the detector 2, and the capacitor C2 and reaches only one polarity (positive polarity) of the discharge lamp La (see FIG. 4 (c)). When the discharge lamp La is extinguished due to the ground fault, no lamp current Ila flows (see FIG. 4 (b)).

Thus, only a positive polarity (positive component) of the output current Io1 is allowed to flow. Therefore, in a period when a negative component of the output current Io1 does not flow, the controller 7 controls the DC/DC converter 1 to increase the output voltage Vo1 relative to that in a normal state thereof. Consequently, with regard to the polarity inverting lamp voltage Vla, there is a difference between an absolute value Va of a voltage value of the positive polarity and an absolute value Vb of a voltage value of the negative polarity (negative component) (see FIG. 4 (a)).

In view of this, the current target calculation unit 7c of the controller 7 acquires information representing the timing of the reversal of the polarity from the driver control unit 7e and stores the lamp voltage detection values (see FIG. 2, the averages of the eight lamp voltage detection values obtained immediately before the timing of the reversal of the polarity) of the respective positive and negative polarities (components) for each reversal of the polarity.

When a state (asymmetric state) where a difference between the lamp voltage detection value of the positive polarity of the lamp voltage and the lamp voltage detection value of the negative polarity of the lamp voltage around the time of the reversal of the polarity of the lamp voltage is not less than a threshold has occurred over the predetermined period T1, the current target calculation unit 7c concludes that an abnormality such as a ground fault has occurred. Note that, the expression “the state has occurred over the predetermined period T1” means “the state has occurred continuously over the predetermined period” and “the state has occurred intermittently within the predetermined period”. Besides, the predetermined period has a predetermined time length. The predetermined period T1 is defined as a period for making the distinction between the occurrence of a temporal state (asymmetric state) due to a cause different from a ground fault and the occurrence of a state (asymmetric state) due to a ground fault.

The controller 7 (the current target calculation unit 7c) is configured to, in the abnormality judgment process, judge whether or not the asymmetric state in which the driving voltage lacks symmetry has occurred over the predetermined period T1, based on the measured value (lamp voltage detection value) obtained from the voltage detector 2a. In more detail, upon acknowledging that an absolute value of one of a first measured value defined as the measured value (lamp voltage detection value) obtained before a reversal of the polarity of the AC voltage (lamp voltage Vla) and a second measured value defined as the measured value (lamp voltage detection value) obtained after the reversal of the polarity of the AC voltage is greater than an absolute value of the other of the first measured value and the second measured value, the controller 7 (the current target calculation unit 7c) conclude that the asymmetric state has occurred.

Upon concluding that the asymmetric state has occurred over the predetermined period T1, the controller 7 concludes that the abnormality has occurred.

The controller 7 (the current target calculation unit 7c) is configured to, upon concluding that the abnormality has occurred, decrease power supplied to the discharge lamp La down to a predetermined value.

For example, the predetermined value is zero. In brief, the controller 7 (the current target calculation unit 7c) terminates supply of power to the discharge lamp La. In this case, the controller 7 (the current target calculation unit 7c) terminates the operation of the lighting circuit unit 10.

For example, the current target calculation unit 7c distinguishes between the lamp voltage detection value of the first polarity having a less absolute value and the lamp voltage detection value of the second polarity having a greater absolute value with regard to the lamp voltage detection values of the polarities obtained before and after the reversal of the polarity. Thereafter, the current target calculation unit 7c calculates a voltage proportion D representing a proportion of the absolute value of the lamp voltage detection value of the second polarity to the absolute value of the lamp voltage detection value of the first polarity. When a state where the voltage proportion D is kept not less than (is kept equal to or more than) the threshold (first threshold) K1 has occurred over the predetermined period T1, the current target calculation unit 7c concludes that the abnormality has occurred. This threshold K1 is selected to satisfy the condition of “K1>1”.

In other words, the controller 7 (the current target calculation unit 7c) calculates the proportion (voltage proportion) D of a larger one of the absolute values of the respective first and second measured values to a smaller one of the absolute values of the respective first and second measured values in the abnormality judgment process. Upon acknowledging that the proportion (voltage proportion) D is not less than the threshold (first threshold) K1, the controller 7 (the current target calculation unit 7c) concludes that a predetermined condition (abnormality judgment condition) has been fulfilled.

Further, upon acknowledging that the asymmetric state continues over the predetermined period, the controller 7 (the current target calculation unit 7c) concludes that the asymmetric state has occurred over the predetermined period. In brief, upon acknowledging that the asymmetric state occurs continuously over the predetermined period, the controller 7 concludes that the abnormality has occurred.

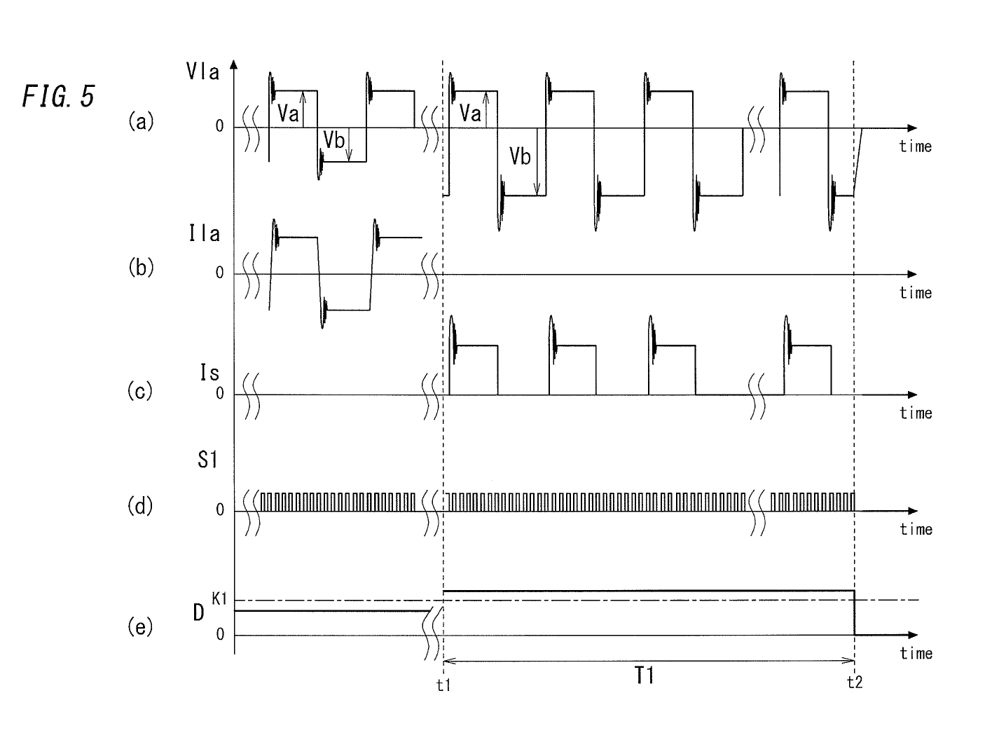

For example, when the waveforms of charts (a) to (e) in FIG. 5 are taken as an instance, a short circuit and a ground fault on the load side are not observed before a time point t1. Hence, the lamp voltage Vla is induced to have symmetry between the positive polarity and the negative polarity. The absolute value Va of the positive polarity of the lamp voltage detection value and the absolute value Vb of the negative polarity of the lamp voltage detection value subsequent to this positive polarity have the substantially same value, and therefore the voltage proportion D is equal to one. Since the voltage proportion D is equal to one and less than the threshold K1, the current target calculation unit 7c concludes that no abnormality has occurred.

Further, before the time point t1, the lamp current Ila flows through the discharge lamp La and the ground fault current Is does not occur. Furthermore, the switching element Q1 is turned on and off in response to the driving signal S1, and the DC/DC converter 1 is in operation.

Next, it is assumed that a ground fault occurs at the point X1 at the time point t1 and then a state where the ground fault resistance Rs is relatively high occurs (see FIG. 1). After the time point t1, the ground fault current Is is generated only at the positive polarity. Consequently, the lamp voltage Vla lacking symmetry between the positive polarity and the negative polarity is generated. Hence, with regard to the lamp voltage detection values, the absolute value Va becomes less than the absolute value Vb, and the voltage proportion D=Vb/Va is obtained.

As mentioned above, the current target calculation unit 7c calculates the proportion (voltage proportion) D=Vb/Va of a larger one (absolute value Vb) of the absolute values Va and Vb of the respective first and second measured values to a smaller one (absolute value Va) of the absolute values Va and Vb of the respective first and second measured values.

When the state (asymmetric state) in which the voltage proportion D=Vb/Va is not less than the threshold K1 has occurred over the predetermined period T1, the current target calculation unit 7c concludes that the abnormality has occurred. Note that, when the absolute value Va is greater than the absolute value Vb, the voltage proportion D is given by D=Va/Vb.

After the current target calculation unit 7c concludes at a time point t2 that the abnormality has occurred, the current target calculation unit 7c adjusts the current target value to zero, and terminates the output of the driving signal S1 to the switching element Q1 to terminate the operation of the DC/DC converter 1.

At this time, also the driver control unit 7e keeps the switching elements Q2 to Q5 in the off-state to terminate the operation of the inverter 3. Consequently, it is possible to prevent the occurrence of an undesired situation where the ground fault current Is continues to flow through the circuit in spite of extinction of the discharge lamp La.

According to the above configuration, even when the first protective function does not work due to relatively high ground fault resistance Rs, the ground fault can be detected by the second protective function. In other words, even when the first protective function does not work in response to the occurrence of the ground fault, the circuit operation is terminated by the second protective function. Therefore, a loss of circuits and a stress of components can be suppressed and the circuit destruction can be prevented.

Note that, the threshold K1 is selected from a range of the voltage proportion which cannot be obtained in a steady lighting state of the discharge lamp La, and is set to a particular value of the voltage proportion obtained in only the load abnormality state.

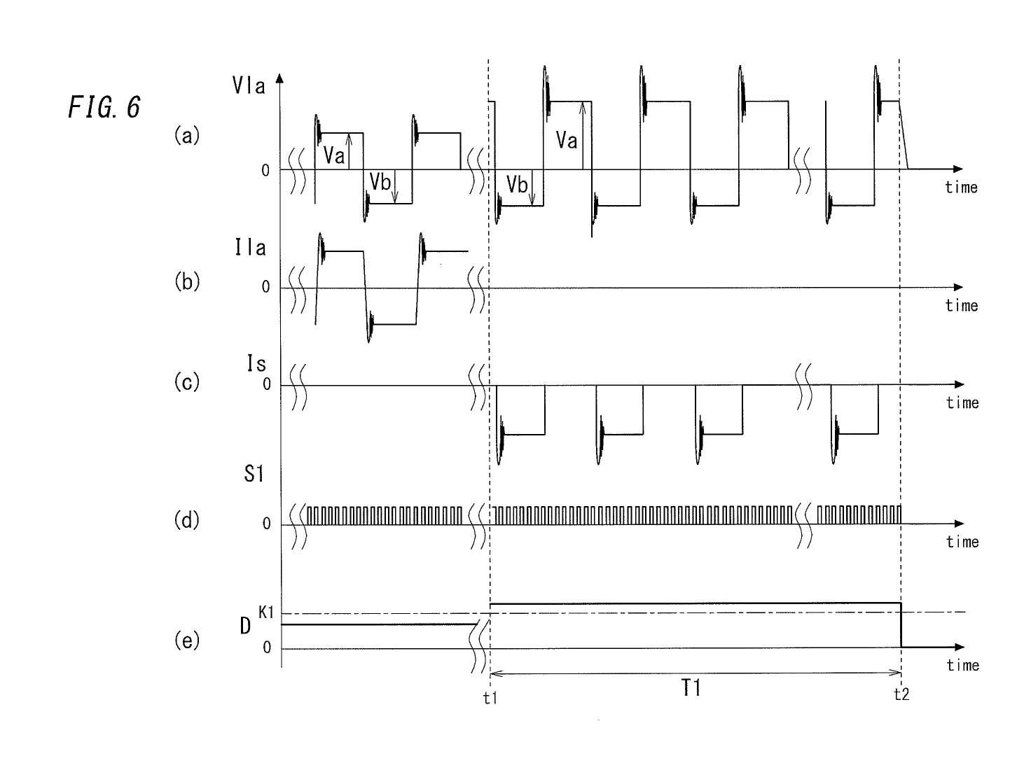

When a situation where a ground fault occurs at a point X2 on the second terminal side of the discharge lamp La and the ground fault resistance Rs is relatively high has occurred (see FIG. 1), the waveforms at particular portions of the present circuit are illustrated in charts (a) to (e) of FIG. 6 respectively.

In this regard, the ground fault current Is is generated only at the other polarity (negative polarity). Consequently, the lamp voltage Vla lacking symmetry between the positive polarity and the negative polarity is generated. Hence, with regard to the lamp voltage detection values, the absolute value Va becomes greater than the absolute value Vb, and the voltage proportion D=Va/Vb is obtained.

As mentioned above, the current target calculation unit 7c calculates the proportion (voltage proportion) D=Va/Vb of a larger one (absolute value Va) of the absolute values Va and Vb of the respective first and second measured values to a smaller one (absolute value Vb) of the absolute values Va and Vb of the respective first and second measured values.

When the state (asymmetric state) in which the voltage proportion D=Va/Vb is not less than the threshold K1 has occurred over the predetermined period T1, the current target calculation unit 7c concludes that the abnormality has occurred.

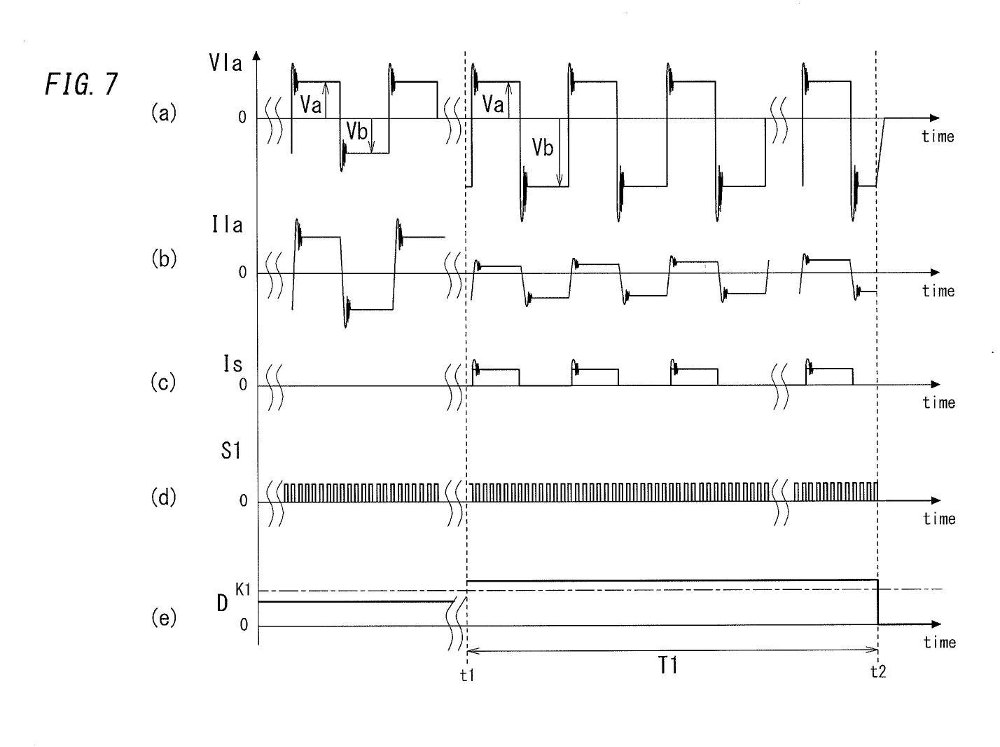

Further, charts (a) to (e) of FIG. 5 show the waveforms at the portions of the present circuit in a situation where the discharge lamp La is extinguished due to a ground fault. In contrast, charts (a) to (e) of FIG. 7 show the waveforms at the portions of the present circuit in a situation where the discharge lamp La is not extinguished even when a ground fault occurs. When the discharge lamp La is not extinguished even when a ground fault occurs, the lamp current Ila continues to flow. However, even when the lamp current Ila flows, the occurrence of the abnormality can be detected as long as the lamp voltage Vla shows asymmetry between the positive polarity and the negative polarity and the voltage proportion D becomes not less than the threshold K1.

The ground fault resistance Rs is not limited to a particular value, but may be 10Ω, 30Ω, or 1 kΩ. The discharge lamp lighting device “A” of the present embodiment can be applied as long as the voltage proportion D becomes not less than the threshold K1 at the time of occurrence of a ground fault.

The aforementioned second protective function of the discharge lamp lighting device “A” also can detect, in addition to a ground fault with the relatively high ground fault resistance, another load abnormality in which the lamp voltage detection value is not decreased equal to or less than the threshold K1, and terminate the circuit operation.

Especially, in the present embodiment, the threshold K1 is selected to be not less than 1.5.

For example, as shown in FIG. 4 (a) to (c), the lamp current Ila does not flow due to a ground fault at the point X1, and the discharge lamp La is extinguished, and the ground fault current Is having the positive polarity occurs. In this situation, when the absolute value Va of the positive polarity is 40 V and the absolute value Vb of the negative polarity is 60 V, the voltage proportion D of the lamp voltage Vla is expressed by D=60/40=1.5.

Since the voltage proportion D=1.5 is not less than the threshold K1=1.5, the current target calculation unit 7c concludes that the abnormality has occurred. Thus, the current target calculation unit 7c terminates the operation of the DC/DC converter 1 and the operation of the inverter 3. Consequently, it is possible to prevent the occurrence of an undesired situation where the ground fault current Is continues to flow through the circuit in spite of extinction of the discharge lamp La.

In this embodiment, the threshold (first threshold) K1 is selected to be equal to or more than 1.5. Thus, the false operation of terminating the circuit operation in response to the false detection of the abnormality while the abnormality (e.g., a short circuit and a ground fault) has not occurred is prevented. Further, even in the end of life of the discharge lamp La, the possibility that the voltage proportion D is equal to or more than 1.5 is extremely low except the oscillation occurs. Hence, the false detection of the abnormality can be prevented. In brief, with selecting the threshold K1 to be not less than 1.5, it is possible to prevent the false operation of terminating the circuit operation in the normal lighting state. Note that, in the present embodiment, the lower limit of the threshold K1 is 1.5 but the upper limit of the threshold K1 is not limited to a particular value. The upper limit of the threshold K1 is selected appropriately to enable detection of an abnormality caused by a ground fault.

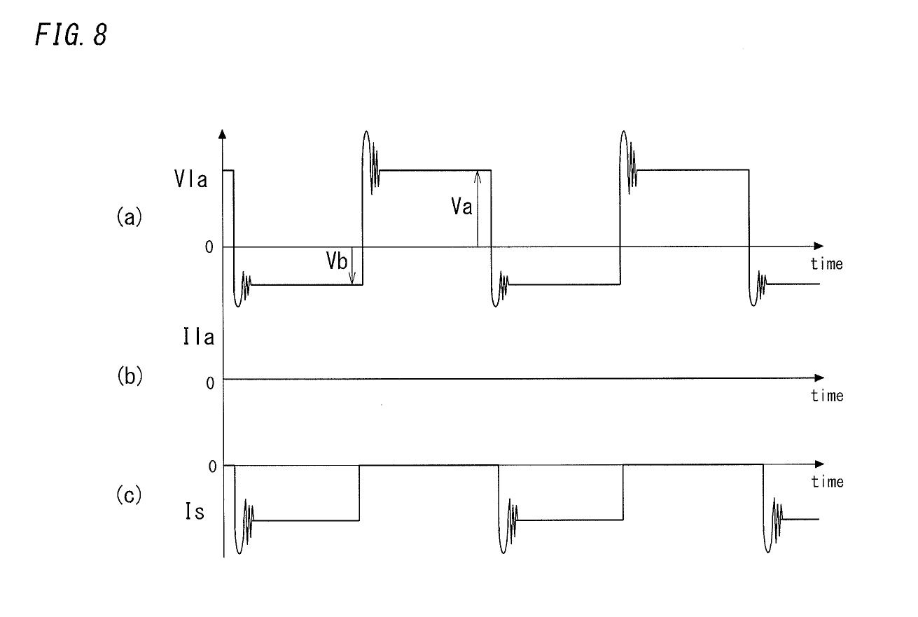

Moreover, as shown in charts (a) to (c) of FIG. 8, for example, the lamp current Ila does not flow due to a ground fault at the point X2, and the discharge lamp La is extinguished, and the ground fault current Is having the negative polarity occurs. When the absolute value Va of the positive polarity of the lamp voltage Vla is 60 V and the absolute value Vb of the negative polarity of the lamp voltage Vla is 40 V, the voltage proportion D is expressed by D=60/40=1.5. Also in this case, since the voltage proportion D=1.5 is not less than the threshold K1=1.5, the current target calculation unit 7c concludes that the abnormality has occurred. As a result, the operations of the DC/DC converter 1 and the inverter 3 can be terminated.

Further, in the present embodiment, the predetermined period T1 is selected to be not less than 10 seconds.

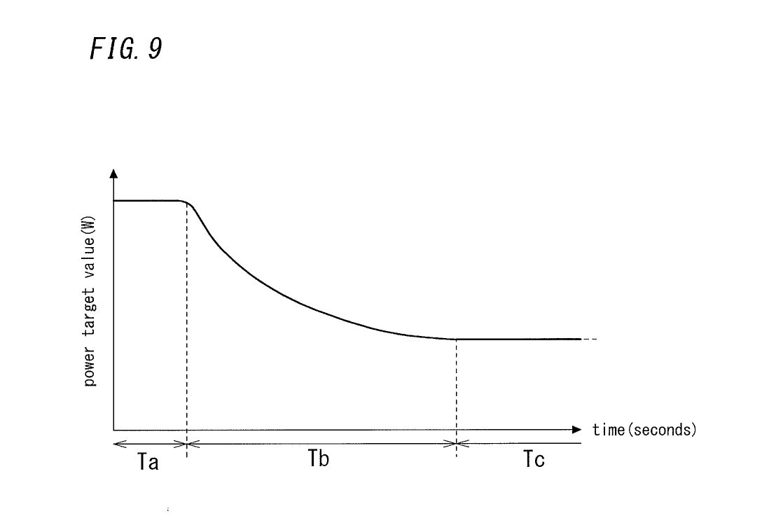

FIG. 9 shows the power target values selected by the maximum power limitation unit 7b of the controller 7. Before the state of the discharge lamp La reaches the stable lighting state from a state of starting to emit the luminous flux after the preheating period, time passes through a period Ta, a period Tb, and a period Tc in this order.

In the period Ta, since the electrodes of the discharge lamp La are not heated enough, there is a possibility of extinction of the discharge lamp La. Further, to rapidly increase the luminous flux of the discharge lamp La, the power target value is selected to be relatively high lamp power (the maximum power target value, e.g., 78 W). The start-up period Ta in which this maximum power target value is maintained has a length in a range of about 5 to 10 seconds.

Thereafter, in the period Tb, the power target value is gradually decreased down to rated power of the discharge lamp La.

Subsequently, in the period Tc, the power target value is kept identical to the rated power (e.g., 35 W) of the discharge lamp La.

In the period Ta, even when the abnormality (e.g., a short circuit and a ground fault) has not occurred, the lamp voltage Vla is likely to have asymmetry between the positive polarity and the negative polarity, and the voltage proportion D also tends to be increased. In view of this, with selecting the predetermined period T1 to be not less than 10 seconds, the termination of the circuit operation can be prevented even in the state of starting to emit the luminous flux in which the voltage proportion D tends to be increased.

Note that, in the present embodiment, the lower limit of the predetermined period T1 is 10 seconds but the upper limit of the predetermined period T1 is not limited to a particular value. The upper limit of the predetermined period T1 is selected appropriately to enable detection of an abnormality caused by a ground fault.

Additionally, when the abnormality is detected by the second protective function at the time of occurrence of a ground fault, the current target calculation unit 7c of the present embodiment decreases the DC output from the DC/DC converter 1 down to predetermined power.

In brief, upon concluding that the abnormality has occurred, the controller 7 decreases power supplied to the discharge lamp La down to a predetermined value. In this regard, the controller 7 gradually decreases the power supplied to the discharge lamp La. In other words, upon concluding that the abnormality has occurred, the controller 7 controls the lighting circuit unit 10 in such a manner to gradually decrease power supplied to the discharge lamp La such that the power supplied to the discharge lamp La becomes identical to a predetermined value after a passage of a predetermined decrease period. Note that, the predetermined decrease period is appropriately selected.

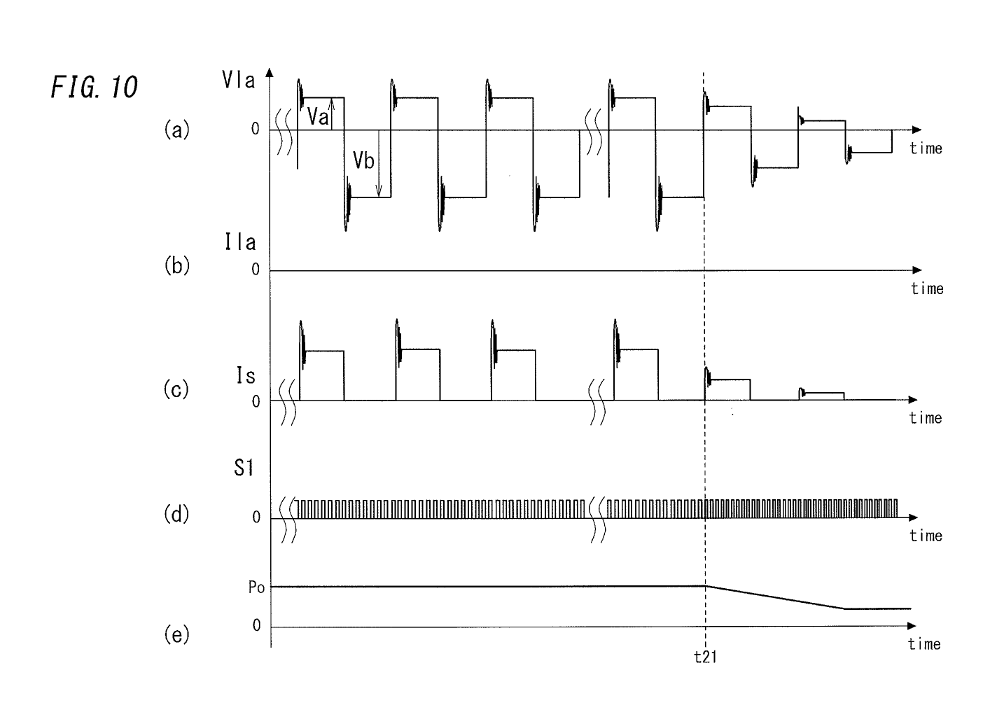

For example, as shown in charts (a) to (e) of FIG. 10, the lamp current Ila does not flow due to a ground fault at the point X1, and the discharge lamp La is extinguished, and the ground fault current Is having the positive polarity occurs. In this situation, the lamp voltage Vla has asymmetry between the absolute value Va of the voltage value of the positive polarity and the absolute value Vb of the voltage value of the negative polarity. When the current target calculation unit 7c concludes, based on the voltage proportion D (or a voltage difference F mentioned below), that the abnormality has occurred (time point t21), the current target calculation unit 7c gradually decreases the current target value.

Consequently, the duty cycle of the driving signal S1 provided to the switching element Q1 is decreased gradually, and, for example, the DC output Po from the DC/DC converter 1 is gradually decreased from 35 W down to 26 W. Throughout this operation, the driver control unit 7e drives the switching elements Q2 to Q5 to continue the operation of the inverter 3. Note that, values (predetermined values) before and after a gradual decrease in the DC output Po may be selected appropriately, and are not limited to particular values. For example, the predetermined value may be zero or more. When the predetermined value is zero, the controller 7 may decrease power supplied to the discharge lamp La down to a certain value and subsequently terminate the operation of the lighting circuit unit 10.

Hence, when a ground fault occurs, the DC output Po from the DC/DC converter 1 is gradually decreased, and the ground fault current Is also is decreased. Therefore, a loss of circuits and a stress of components can be suppressed and the circuit destruction can be prevented.

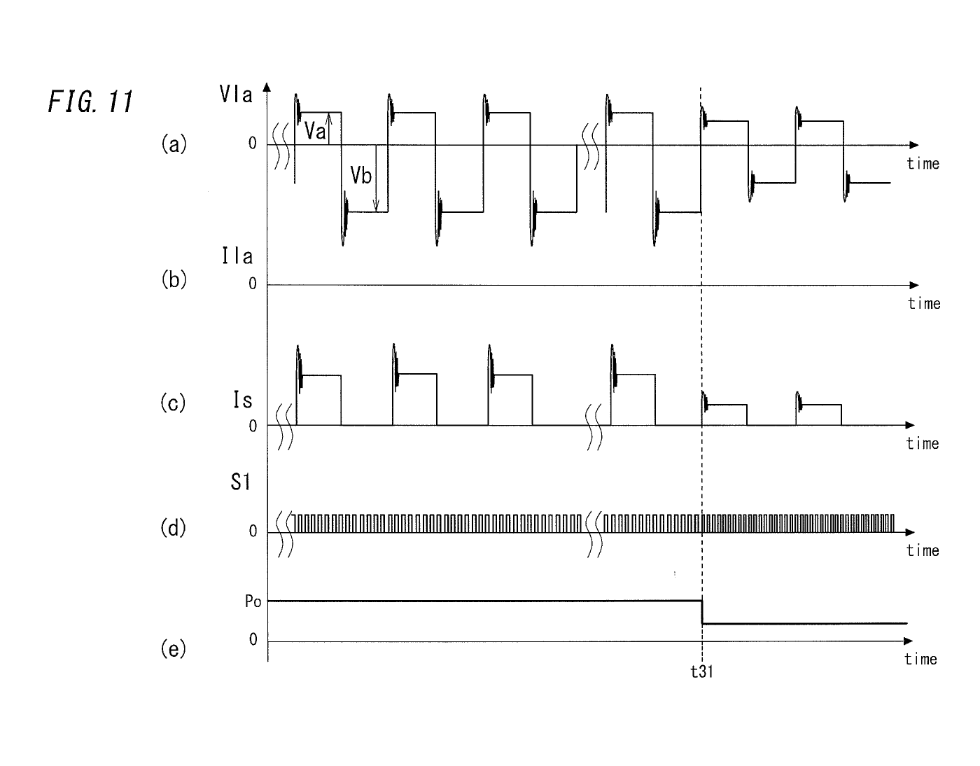

Alternatively, as shown in charts (a) to (e) of FIG. 11, upon acknowledging based on the voltage proportion D that the abnormality has occurred (time point t31), the current target calculation unit 7c may decrease the current target value in a stepwise manner. In this arrangement, the DC output Po from the DC/DC converter 1 is decreased in a stepwise manner.

Note that, the controller 7 does not necessarily need to decrease power supplied to the discharge lamp La gradually. Hence, upon concluding that the abnormality has occurred, the controller 7 may decrease power supplied to the discharge lamp La down to a predetermined value immediately. In this modification, the controller 7 may immediately terminate the operation of the lighting circuit unit 10 upon concluding that the abnormality has occurred.

Additionally, the discharge lamp lighting device “A” of the present embodiment enables the second protective function using the voltage proportion D after the state of the discharge lamp La is changed from the state in the start-up period to the state in the steady lighting period.

With regard to FIG. 9, the periods Ta and Tb are start-up periods, and the period Tc is the steady lighting period. The controller 7 activates the second protective operation after the state of the discharge lamp La is changed from the state in the start-up periods Ta and Tb to the state in the steady lighting period Tc.

In this manner, the second protective function using the voltage proportion D is not activated in the start-up periods Ta and Tb in which the lamp voltage Vla fluctuates greatly. Consequently, it is possible to prevent the false operation of terminating the circuit operation in response to the false detection of the abnormality in the start-up periods Ta and Tb.

As mentioned above, the discharge lamp lighting device “A” of the present embodiment includes the power converter (DC/DC converter) 1, the inverter 3, the voltage detector 2a, the current detector 2b, and the controller 7. The DC/DC converter 1 converts inputted power into desired DC power. The inverter 3 converts a DC voltage outputted from the power converter 1 into an AC voltage, and outputs the resultant AC voltage to the discharge lamp La. The voltage detector 2a detects a voltage supplied to the discharge lamp La. The current detector 2b detects a current supplied to the discharge lamp La. The controller 7 adjusts DC power outputted from the power converter 1 based on the voltage detection value of the voltage detector 2a and the current detection value of the current detector 2b. The controller 7 stores the voltage detection values of the respective polarities for each reversal of the polarity of the AC voltage. When a state where a difference not less than the threshold occurs between the voltage detection value of one polarity and the voltage detection value of the other polarity respectively obtained before and after the reversal of the polarity has occurred over the predetermined period, the controller 7 concludes that the abnormality has occurred.

Further, in the discharge lamp lighting device “A” of the present embodiment, the controller 7 distinguishes between the lamp voltage detection value of the first polarity having a less absolute value and the lamp voltage detection value of the second polarity having a greater absolute value with regard to the lamp voltage detection values of the polarities obtained before and after the reversal of the polarity. The controller calculates the voltage proportion representing the proportion of the absolute value of the lamp voltage detection value of the second polarity to the absolute value of the lamp voltage detection value of the first polarity. When a state where the voltage proportion is kept not less than the threshold has occurred over the predetermined period, the controller 7 concludes that the abnormality has occurred.

Further, in the discharge lamp lighting device “A” of the present embodiment, the threshold (first threshold) K1 is not less than 1.5.

Further, in the discharge lamp lighting device “A” of the present embodiment, the predetermined period T1 has a predetermined time length.

Further, in the discharge lamp lighting device “A” of the present embodiment, the predetermined period T1 is not less than 10 seconds.

Further, in the discharge lamp lighting device “A” of the present embodiment, the controller 7 terminates supplying power to the discharge lamp La or decreases power supplied to the discharge lamp La when concluding that the abnormality has occurred.

Further, in the discharge lamp lighting device “A” of the present embodiment, the controller 7 gradually decreases power supplied to the discharge lamp La when concluding that the abnormality has occurred.

Further, in the discharge lamp lighting device “A” of the present embodiment, the controller 7 performs a process of detecting the abnormality after the state of the discharge lamp La is changed from the state in the start-up period to the state in the steady lighting period.

In other words, the discharge lamp lighting device “A” of the present embodiment includes the following first to twelfth features. Note that, the second to twelfth features are optional.

As for the first feature, the discharge lamp lighting device “A” of the present embodiment includes the controller 7 configured to perform the abnormality judgment process of judging whether or not the abnormality has occurred, based on the measured value of the driving voltage defined as the AC voltage applied to the discharge lamp La. The controller 7 is configured to, in the abnormality judgment process, judge whether or not the asymmetric state in which the driving voltage lacks symmetry has occurred over the predetermined period T1. The controller 7 is configured to, upon concluding that the asymmetric state has occurred over the predetermined period T1, conclude that the abnormality has occurred.

As for the second feature, in addition to the first feature, the controller 7 is configured to, upon acknowledging that the absolute value of one of the first measured value defined as the measured value obtained before a reversal of polarity of the driving voltage and the second measured value defined as the measured value obtained after the reversal of polarity of the driving voltage is greater than the absolute value of the other of the first measured value and the second measured value, conclude that the asymmetric state has occurred.

As for the third feature, in addition to the second feature, the controller 7 is configured to, in the abnormality judgment process, calculate the proportion (voltage proportion) D of a larger one of the absolute values of the respective first and second measured values to a smaller one of the absolute values of the respective first and second measured values and, upon acknowledging that the proportion D is not less than the threshold (first threshold) K1, conclude that the asymmetric state has occurred.

As for the fourth feature, in addition to the third feature, the threshold (first threshold) K1 is not less than 1.5.

As for the fifth feature, in addition to any one of the first to fourth features, the controller 7 is configured to, upon acknowledging that the state (asymmetric state) continues for the predetermined period T1, conclude that the state (asymmetric state) has occurred over the predetermined period T1.

As for the sixth feature, in addition to the fifth feature, the predetermined period T1 has a length equal to that of the start-up period Ta of the discharge lamp La.

As for the seventh feature, in addition to the fifth or sixth feature, the predetermined period T1 has a length not less than 10 seconds.

As for the eighth feature, in addition to any one of the first to seventh features, the discharge lamp lighting device “A” further includes the lighting circuit unit 10 having a function of applying an AC voltage to the discharge lamp La. The controller 7 is configured to control the lighting circuit unit 10 to adjust power supplied to the discharge lamp La.

As for the ninth feature, in addition to the eighth feature, the lighting circuit unit 10 includes the power converter 1, the inverter 3, the voltage detector 2a, and the current detector 2b. The power converter 1 is configured to generate DC power by use of power from an external power source (e.g., the DC power source E1). The inverter 3 is configured to apply an AC voltage to the discharge lamp La by use of the DC power generated by the power converter 1. The voltage detector 2a is configured to measure a voltage (lamp voltage Vla) applied to the discharge lamp La. The current detector 2b is configured to measure a current (lamp current Ila) flowing through the discharge lamp La. The controller 7 is configured to adjust the DC power generated by the power converter 1 based on a measured value of the voltage detector 2a and a measured value of the current detector 2b.

As for the tenth feature, in addition to the eighth or ninth feature, the controller 7 is configured to, upon concluding that the abnormality has occurred, decrease power supplied to the discharge lamp La down to a predetermined value.

As for the eleventh feature, in addition to the tenth feature, the controller 7 is configured to gradually decrease power supplied to the discharge lamp La.

As for the twelfth feature, in addition to any one of the first to eleventh features, the controller 7 is configured to start the abnormality judgment process after the discharge lamp La is changed from the state in the start-up period to the state in the steady lighting period.

As explained above, even when a ground fault occurs with a relatively high ground fault resistance, the discharge lamp lighting device “A” of the present embodiment can detect such a ground fault. In other words, since the circuit operation is terminated in response to a ground fault, a loss of circuits and a stress of components can be suppressed and the circuit destruction can be prevented.

### Second Embodiment

In the present embodiment, the controller 7 has the second protective function using a voltage difference limitation of the lamp voltage. Besides, the present embodiment includes the other configurations same as those of the first embodiment, and such configurations are designated by the same reference numerals, and explanations thereof are deemed unnecessary.

The current target calculation unit 7c of the controller 7 calculates a voltage difference F representing a difference between the absolute value of the lamp voltage detection value of the first polarity and the absolute value of the lamp voltage detection value of the second polarity. When a state where the voltage difference F is kept not less than (is kept equal to or more than) a threshold (second threshold) K2 has occurred over a predetermined period T2, the current target calculation unit 7c concludes that the abnormality has occurred. This threshold (second threshold) K2 is selected to satisfy the condition of “K2>0”.

In other words, the controller 7 (the current target calculation unit 7c) calculates the difference (voltage difference) F between the absolute values of the respective first and second measured values in the abnormality judgment process. Upon acknowledging that the difference (voltage difference) F is not less than the threshold (second threshold) K2, the controller 7 (the current target calculation unit 7c) concludes that the asymmetric state has occurred.

Further, like the first embodiment, upon acknowledging that the asymmetric state continues over the predetermined period T2, the controller 7 (the current target calculation unit 7c) concludes that the asymmetric state has occurred over the predetermined period T2. In brief, upon acknowledging that the asymmetric state occurs continuously over the predetermined period T2, the controller 7 concludes that the abnormality has occurred.

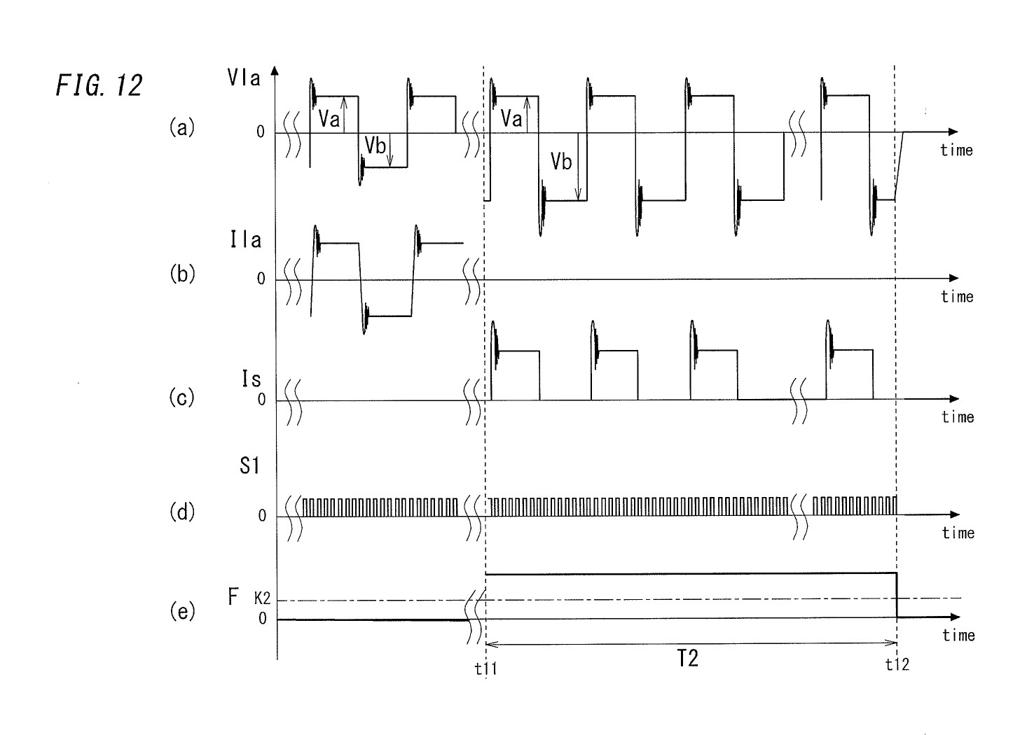

For example, when the waveforms of charts (a) to (e) in FIG. 12 are taken as an instance, a short circuit and a ground fault on the load side are not observed before a time point t11. Hence, the lamp voltage Vla is induced to have symmetry between the positive polarity and the negative polarity. The absolute value Va of the positive polarity of the lamp voltage detection value and the absolute value Vb of the negative polarity of the lamp voltage detection value subsequent to this positive polarity have the substantially same value, and therefore the voltage difference F is expressed as F=|Vb−Va|=0. Since the voltage difference F is equal zero and less than the threshold K2, the current target calculation unit 7c concludes that no abnormality has occurred.

Further, before the time point t11, the lamp current Ila flows through the discharge lamp La and the ground fault current Is does not occur. Furthermore, the switching element Q1 is turned on and off in response to the driving signal S1, and the DC/DC converter 1 is in operation.

Next, it is assumed that a ground fault occurs at the point X1 at the time point t11 and then a state where the ground fault resistance Rs is relatively high occurs (see FIG. 1). After the time point t11, the ground fault current Is is generated only at the positive polarity. Consequently, the lamp voltage Vla lacking symmetry between the positive polarity and the negative polarity is generated. Hence, with regard to the lamp voltage detection values, the absolute value Va becomes less than the absolute value Vb, and the voltage difference F=|Vb−Va|>0 is obtained.

As mentioned above, the current target calculation unit 7c calculates the difference (voltage difference) F between the absolute values Va and Vb of the respective first and second measured values.

When the state (asymmetric state) in which the voltage difference F=|Vb−Va| is not less than the threshold K2 has occurred over the predetermined period T2, the current target calculation unit 7c concludes that the abnormality has occurred.

After the current target calculation unit 7c concludes at a time point t12 that the abnormality has occurred, the current target calculation unit 7c adjusts the current target value to zero, and terminates the output of the driving signal S1 to the switching element Q1 to terminate the operation of the DC/DC converter 1.

At this time, also the driver control unit 7e keeps the switching elements Q2 to Q5 in the off-state to terminate the operation of the inverter 3. Consequently, it is possible to prevent the occurrence of an undesired situation where the ground fault current Is continues to flow through the circuit in spite of extinction of the discharge lamp La.

According to the above configuration, even when the first protective function does not work due to relatively high ground fault resistance Rs, the ground fault can be detected by the second protective function. In other words, even when the first protective function does not work in response to the occurrence of the ground fault, the circuit operation is terminated by the second protective function. Therefore, a loss of circuits and a stress of components can be suppressed and the circuit destruction can be prevented.

Note that, the threshold K2 is selected from a range of the voltage proportion which cannot be obtained in a steady lighting state of the discharge lamp La, and is set to a particular value of the voltage proportion obtained in only the load abnormality state.

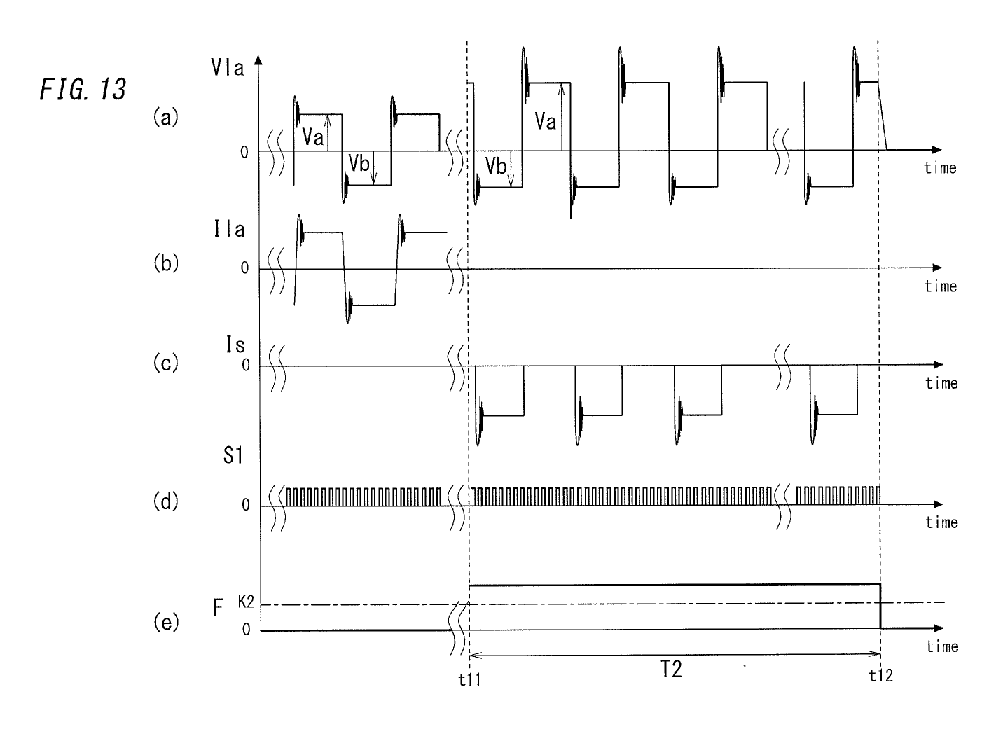

When a situation where a ground fault occurs at the point X2 on the second terminal side of the discharge lamp La and the ground fault resistance Rs is relatively high has occurred (see FIG. 1), the waveforms at particular portions of the present circuit are illustrated in charts (a) to (e) of FIG. 13 respectively.

In this regard, the ground fault current Is is generated only at the other polarity (negative polarity). Consequently, the lamp voltage Vla lacking symmetry between the positive polarity and the negative polarity is generated. Hence, with regard to the lamp voltage detection values, the absolute value Va becomes greater than the absolute value Vb, and the voltage difference F=|Va−Vb|>0 is obtained.

As mentioned above, the current target calculation unit 7c calculates the difference (voltage difference) F between the absolute values Va and Vb of the respective first and second measured values.

When the state (asymmetric state) in which the voltage difference F=|Vb−Va| is not less than the threshold K2 has occurred over the predetermined period T2, the current target calculation unit 7c concludes that the abnormality has occurred.

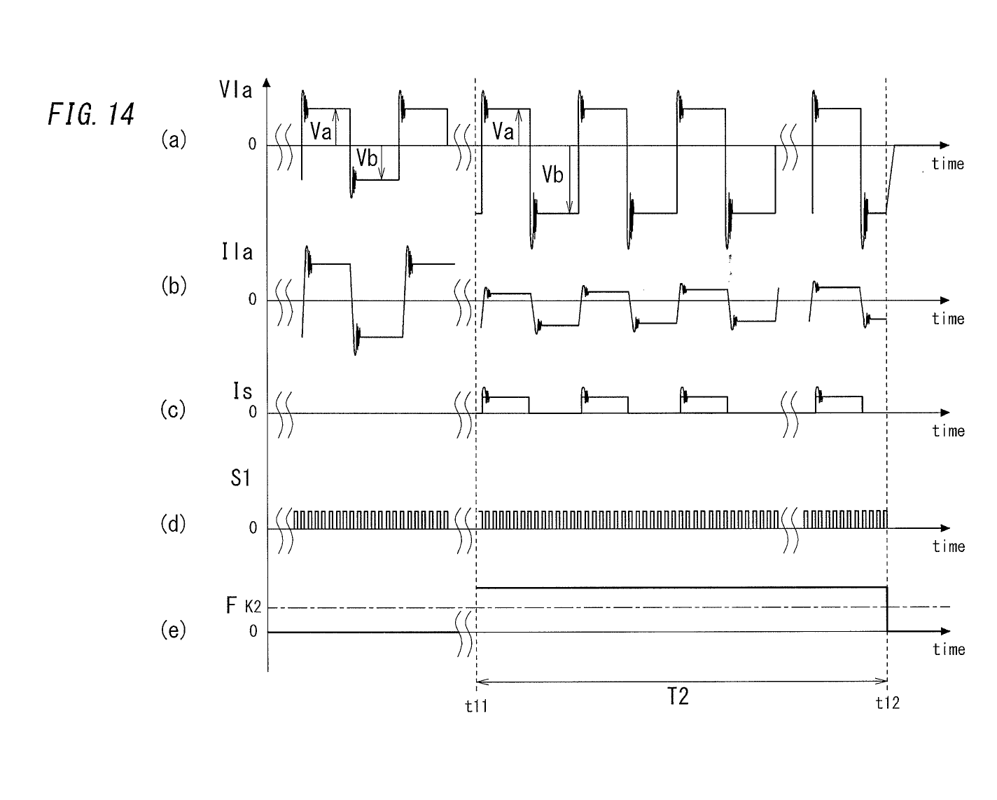

Further, charts (a) to (e) of FIG. 12 show the waveforms at the portions of the present circuit in a situation where the discharge lamp La is extinguished due to a ground fault. In contrast, charts (a) to (e) of FIG. 14 show the waveforms at the portions of the present circuit in a situation where the discharge lamp La is not extinguished even when a ground fault occurs. When the discharge lamp La is not extinguished even when a ground fault occurs, the lamp current Ila continues to flow. However, even when the lamp current Ila flows, the occurrence of the abnormality can be detected as long as the lamp voltage Vla shows asymmetry between the positive polarity and the negative polarity and the voltage difference F=|Vb−Va| becomes not less than the threshold K2.

The ground fault resistance Rs is not limited to a particular value, but may be 10Ω, 30Ω, or 1 kΩ. The discharge lamp lighting device “A” of the present embodiment can be applied as long as the voltage difference F becomes not less than the threshold K2 at the time of occurrence of a ground fault.

In the present embodiment, the threshold K2 is selected to be not less than one-half of the rated lamp voltage (rated voltage) of the discharge lamp La.

For example, as shown in FIG. 4 (a) to (c), the lamp current Ila does not flow due to a ground fault at the point X1, and the discharge lamp La is extinguished, and the ground fault current Is having the positive polarity occurs. In this situation, when the absolute value Va of the positive polarity is 40 V and the absolute value Vb of the negative polarity is 60 V, the voltage difference F of the lamp voltage Vla is expressed by F=|60−40|=20 V.

In this regard, the rated voltage of the discharge lamp La is 40 V, and the threshold K2 is 20 V which is one-half of the rated voltage of 40 V. Since the voltage difference F=20 V is not less than the threshold K2=20 V, the current target calculation unit 7c concludes that the abnormality has occurred. Thus, the current target calculation unit 7c terminates the operation of the DC/DC converter 1 and the operation of the inverter 3. Consequently, it is possible to prevent the occurrence of an undesired situation where the ground fault current Is continues to flow through the circuit in spite of extinction of the discharge lamp La.

In this embodiment, the threshold (second threshold) K2 is set to 20 V which is one-half of the rated voltage of the discharge lamp La. Thus, the false operation of terminating the circuit operation in response to the false detection of the abnormality while the abnormality (e.g., a short circuit and a ground fault) has not occurred is prevented. Further, even in the end of life of the discharge lamp La, the possibility that the voltage difference F is equal to or more than 20 V is extremely low except the oscillation occurs. Hence, the false detection of the abnormality can be prevented. In brief, with selecting the threshold K2 to be not less than 20 V, it is possible to prevent the false operation of terminating the circuit operation in the normal lighting state. Note that, in the present embodiment, the lower limit of the threshold K2 is identical to one-half of the rated voltage of the discharge lamp La but the upper limit of the threshold K2 is not limited to a particular value. The upper limit of the threshold K2 is selected appropriately to enable detection of an abnormality caused by a ground fault.

Moreover, as shown in charts (a) to (c) of FIG. 8, for example, the lamp current Ila does not flow due to a ground fault at the point X2, and the discharge lamp La is extinguished, and the ground fault current Is having the negative polarity occurs. When the absolute value Va of the positive polarity of the lamp voltage Vla is 60 V and the absolute value Vb of the negative polarity of the lamp voltage Vla is 40 V, the voltage difference F is expressed by F=|60−40|=20 V. Also in this case, since the voltage difference F=20 V is not less than the threshold K2=20 V, the current target calculation unit 7c concludes that the abnormality has occurred. As a result, the operation of the DC/DC converter 1 and the operation of the inverter 3 can be terminated.

Further, in the present embodiment, the predetermined period T2 is selected to be not less than 10 seconds.

In the start-up period Ta, even when the abnormality (e.g., a short circuit and a ground fault) has not occurred, the lamp voltage Vla is likely to have asymmetry between the positive polarity and the negative polarity, and the voltage difference F also tends to be increased. In view of this, with selecting the predetermined period T2 to be not less than 10 seconds, the termination of the circuit operation can be prevented even in the state of starting to emit the luminous flux in which the voltage difference F tends to be increased.

Note that, in the present embodiment, the lower limit of the predetermined period T2 is 10 seconds but the upper limit of the predetermined period T2 is not limited to a particular value. The upper limit of the predetermined period T2 is selected appropriately to enable detection of an abnormality caused by a ground fault.

Additionally, when the abnormality is detected by the second protective function at the time of occurrence of a ground fault, the current target calculation unit 7c of the present embodiment decreases the DC output from the DC/DC converter 1 down to predetermined power.

For example, as shown in charts (a) to (e) of FIG. 10, the lamp current Ila does not flow due to a ground fault at the point X1, and the discharge lamp La is extinguished, and the ground fault current Is having the positive polarity occurs. In this situation, the lamp voltage Vla has asymmetry between the absolute value Va of the voltage value of the positive polarity and the absolute value Vb of the voltage value of the negative polarity. When the current target calculation unit 7c concludes, based on the voltage difference F, that the abnormality has occurred (time point t21), the current target calculation unit 7c gradually decreases the current target value.

Consequently, the duty cycle of the driving signal S1 provided to the switching element Q1 is decreased gradually, and, for example, the DC output Po from the DC/DC converter 1 is gradually decreased from 35 W down to 26 W. Throughout this operation, the driver control unit 7e drives the switching elements Q2 to Q5 to continue the operation of the inverter 3. Note that, values (predetermined values) before and after a gradual decrease in the DC output Po may be selected appropriately, and are not limited to particular values. For example, the predetermined value may be zero or more. When the predetermined value is zero, the controller 7 may decrease power supplied to the discharge lamp La down to a certain value and subsequently terminate the operation of the lighting circuit unit 10.

Hence, when a ground fault occurs, the DC output Po from the DC/DC converter 1 is gradually decreased, and the ground fault current Is also is decreased. Therefore, a loss of circuits and a stress of components can be suppressed and the circuit destruction can be prevented.

Alternatively, as shown in charts (a) to (e) of FIG. 11, upon acknowledging based on the voltage difference F that the abnormality has occurred (time point t31), the current target calculation unit 7c may decrease the current target value in a stepwise manner. In this arrangement, the DC output Po from the DC/DC converter 1 is decreased in a stepwise manner.

Additionally, the discharge lamp lighting device “A” of the present embodiment enables the second protective function using the voltage difference F after the state of the discharge lamp La is changed from the state in the start-up period to the state in the steady lighting period.

With regard to FIG. 9, the periods Ta and Tb are the start-up periods, and the period Tc is the steady lighting period. The controller 7 activates the second protective operation after the state of the discharge lamp La is changed from the state in the start-up periods Ta and Tb to the state in the steady lighting period Tc.

In this manner, the second protective function using the voltage difference F is not activated in the start-up periods Ta and Tb in which the lamp voltage Vla fluctuates greatly. Consequently, it is possible to prevent the false operation of terminating the circuit operation in response to the false detection of the abnormality in the start-up periods Ta and Tb.

Note that, the controller 7 does not necessarily need to decrease power supplied to the discharge lamp La gradually. Hence, upon concluding that the abnormality has occurred, the controller 7 may decrease power supplied to the discharge lamp La down to a predetermined value immediately. In this modification, the controller 7 may immediately terminate the operation of the lighting circuit unit 10 upon concluding that the abnormality has occurred.

As mentioned above, in the discharge lamp lighting device “A” of the present embodiment, the controller 7 calculates the voltage difference F representing the difference between the absolute value of the lamp voltage detection value of the first polarity and the absolute value of the lamp voltage detection value of the second polarity respectively obtained before and after the reversal of the polarity. When the state (asymmetry state) where the voltage difference F is kept not less than (is kept equal to or more than) the threshold K2 has occurred over the predetermined period T2, the controller 7 concludes that the abnormality has occurred.

Further, in the discharge lamp lighting device “A” of the present embodiment, the threshold (second threshold) K2 is not less than one-half of the rated lamp voltage of the discharge lamp La.

In other words, the discharge lamp lighting device “A” of the present embodiment includes the following thirteenth and fourteenth features in addition to the aforementioned first and second features. Note that, the fourteenth feature is optional.

As for the thirteenth feature, the controller 7 is configured to calculate the difference (voltage difference) F between the absolute values of the respective first and second measured values and, upon acknowledging that an absolute value of the difference (voltage difference) F is not less than the threshold (second threshold) K2, conclude that the asymmetric state has occurred.

As for the fourteenth feature, the threshold (second threshold) K2 is not less than one-half of the rated lamp voltage of the discharge lamp La.

Moreover, the discharge lamp lighting device “A” of the present embodiment may include one or more optional features selected from the aforementioned fifth to twelfth features.

### Third Embodiment

In the present embodiment, when the current target calculation unit 7c concludes, by use of the second protective function, that the abnormality has occurred, the driver control unit 7e terminates the polarity reversal function of the inverter 3 and controls the inverter 3 in such a manner to output a DC voltage therefrom. Besides, the present embodiment includes the other configurations same as those of the first or second embodiment, and such configurations are designated by the same reference numerals, and explanations thereof are deemed unnecessary.

The lighting circuit unit 10 includes the DC/DC converter 1 and the inverter 3. The lighting circuit unit 10 outputs an AC voltage by turning on and off alternately the set of the switching elements Q2 and Q5 and the set of the switching elements Q3 and Q4 of the inverter 3.

Additionally, the lighting circuit unit 10 can output a DC voltage with the positive polarity (i.e., a positive DC voltage) by keeping the set of the switching elements Q2 and Q5 of the inverter 3 turned on and the set of the switching elements Q3 and Q4 of the inverter 3 turned off. Further, the lighting circuit unit 10 can output a DC voltage with the negative polarity (i.e., a negative DC voltage) by keeping the set of the switching elements Q2 and Q5 of the inverter 3 turned off and the set of the switching elements Q3 and Q4 of the inverter 3 turned on.

In brief, the lighting circuit unit 10 has a function of applying a DC voltage with the positive or negative polarity to the discharge lamp La, in addition to the function of applying an AC voltage to the discharge lamp La.

In the present embodiment, the controller 7 is configured to, upon concluding that the abnormality has occurred, control the lighting circuit unit 10 in such a manner to supply to the discharge lamp La a DC voltage having the same polarity as that corresponding to larger one of the absolute values of the respective first and second measured values.

When larger one of the absolute values of the respective first and second measured values is corresponding to the positive polarity, the controller 7 controls the lighting circuit unit 10 in such a manner to supply a DC voltage with the positive polarity to the discharge lamp La. For example, the controller 7 keeps turning on the switching elements Q2 and Q5 of the inverter 3 and turning off the switching elements Q3 and Q4 of the inverter 3, thereby supplying a DC voltage with the positive polarity (a positive DC voltage) to the discharge lamp La from the lighting circuit unit 10. In this situation, the point X1 on the first end side of the discharge lamp La has an electrical potential higher than that at the point X2 on the second end side of the discharge lamp La.

In contrast, when larger one of the absolute values of the respective first and second measured values is corresponding to the negative polarity, the controller 7 controls the lighting circuit unit 10 in such a manner to supply a DC voltage with the negative polarity to the discharge lamp La. For example, the controller 7 keeps turning off the switching elements Q2 and Q5 of the inverter 3 and turning on the switching elements Q3 and Q4 of the inverter 3, thereby supplying a DC voltage with the negative polarity (a negative DC voltage) to the discharge lamp La from the lighting circuit unit 10. In this situation, the point X1 on the first end side of the discharge lamp La has an electrical potential lower than that at the point X2 on the second end side of the discharge lamp La.

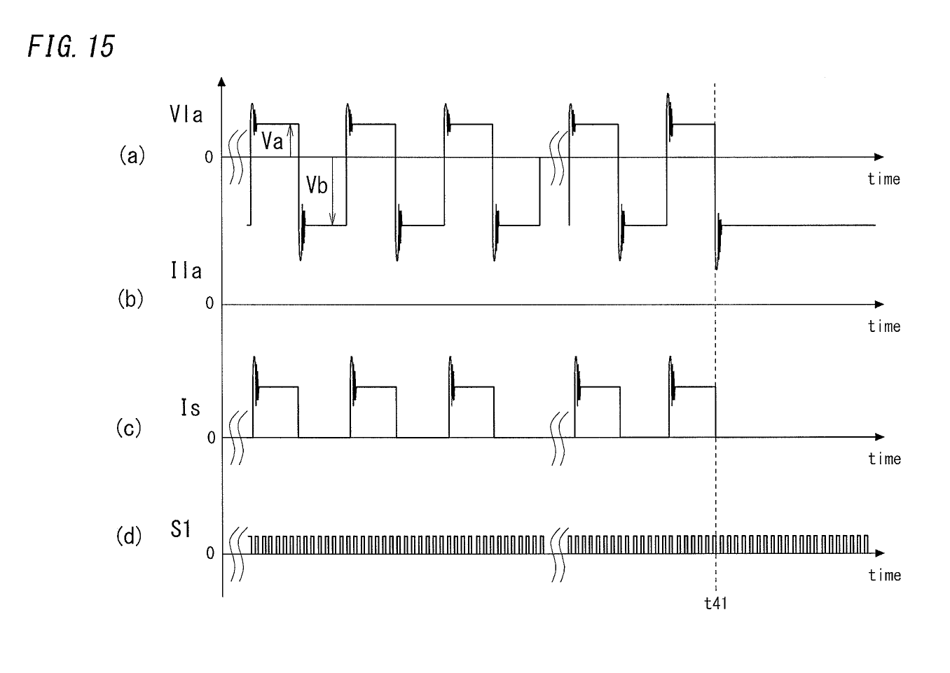

For example, as shown in FIG. 15 (a) to (d), the lamp current Ila does not flow due to a ground fault at the point X1, and the discharge lamp La is extinguished, and the ground fault current Is having the positive polarity occurs. In this situation, the lamp voltage Vla has asymmetry between the absolute value Va of the positive polarity and the absolute value Vb of the negative polarity.

When the current target calculation unit 7c concludes, based on the voltage proportion D or the voltage difference F, that the abnormality has occurred (time point t41), the driver control unit 7e terminates the switching operation of the switching elements Q2 to Q5 of the inverter 3 to deactivate the polarity reversal function of the inverter 3.

While a ground fault occurs, the absolute value Vb of the negative polarity is greater than the absolute value Va of the positive polarity. Hence, the driver control unit 7e controls the switching elements Q2 to Q5 to allow the inverter 3 to output a DC voltage with the negative polarity having the higher absolute value.

In brief, the controller 7 controls the lighting circuit unit 10 in such a manner to supply to the discharge lamp La a DC voltage having the same polarity (negative polarity) as that corresponding to larger one (the absolute value Vb) of the absolute values Va and Vb of the respective first and second measured values.

Specifically, the driver control unit 7e keeps the switching elements Q3 and Q4 in the on-state and keeps the switching elements Q2 and Q5 in the off-state such that the inverter 3 outputs a DC voltage with the negative polarity. Note that, even after the controller 7 concludes, based on the voltage proportion D or the voltage difference F, that the abnormality has occurred, the controller 7 continues to output the driving signal S1 to turn on and off the switching element Q1.

Accordingly, when a ground fault occurs, the inverter 3 outputs a DC voltage having the relatively high absolute value. Thus, no ground fault Is flows. Consequently, a loss of circuits and a stress of components can be suppressed and the circuit destruction can be prevented.

For example, when the lamp current Ila does not flow due to a ground fault at the point X2, and the discharge lamp La is extinguished, and the ground fault current Is occurs, the driver control unit 7e controls the switching elements Q2 to Q5 to allow the inverter 3 to output a DC voltage with the positive polarity having the higher absolute value. In brief, the controller 7 controls the lighting circuit unit 10 in such a manner to supply to the discharge lamp La a DC voltage having the same polarity (positive polarity) as that corresponding to larger one (the absolute value Va) of the absolute values Va and Vb of the respective first and second measured values.

Specifically, the driver control unit 7e keeps the switching elements Q2 and Q5 in the on-state and keeps the switching elements Q3 and Q4 in the off-state such that the inverter 3 outputs a DC voltage with the positive polarity. Also in this situation, since no ground fault Is flows, a loss of circuits and a stress of components can be suppressed and the circuit destruction can be prevented.

As mentioned above, in the discharge lamp lighting device “A” of the present embodiment, upon concluding that the abnormality has occurred, the controller 7 controls the inverter 3 such that the inverter 3 outputs a DC voltage with a polarity corresponding to the higher absolute value of the voltage detection value out of the first polarity and the second polarity.

In other words, the discharge lamp lighting device “A” of the present embodiment includes the following fifteenth feature in addition to the first and eighth features. As for the fifteenth feature, the lighting circuit unit 10 has a function of applying a DC voltage to the discharge lamp La. The controller 7 is configured to, upon concluding that the abnormality has occurred, control the lighting circuit unit 10 in such a manner to supply to the discharge lamp La a DC voltage having the same polarity as that corresponding to larger one of the absolute values of the respective first and second measured values.

Note that, the discharge lamp lighting device “A” of the present embodiment may include one or more optional features selected from the aforementioned second to seventh, ninth, and twelfth features. Further, the discharge lamp lighting device “A” of the present embodiment may include one or more optional features selected from the aforementioned thirteenth and fourteenth features, instead of the aforementioned third and fourth features.

### Fourth Embodiment

The controller 7 of the present embodiment is configured to, when the number of times that the voltage proportion D is not less than the threshold K1 or the number of times that the voltage difference F is not less than the threshold K2 is not less than a predetermined number of times before a passage of a predefined period (prescribed period) T3, conclude that the abnormality has occurred. Besides, the present embodiment includes the other configurations same as those of any one of the first to third embodiments, and such configurations are designated by the same reference numerals, and explanations thereof are deemed unnecessary.

In other words, the controller 7 is configured to, upon acknowledging that the number of times of occurrence of the state (asymmetric state) is not less than the predetermined number of times N before a passage of the prescribed period T3, conclude that the state (asymmetric state) has occurred over the predetermined period T1 (or T2).

For example, the prescribed period T3 may have the same length as that of the predetermined period T1 (or T2), and may have a length shorter than that of the predetermined period T1 (or T2). Preferably, the predetermined number of times N is not less than two.

The prescribed period T3 and the predetermined number of times N are selected such that the occurrence of a temporal state (asymmetric state) due to a cause different from a ground fault can be distinguished from the occurrence of a state (asymmetric state) due to a ground fault.

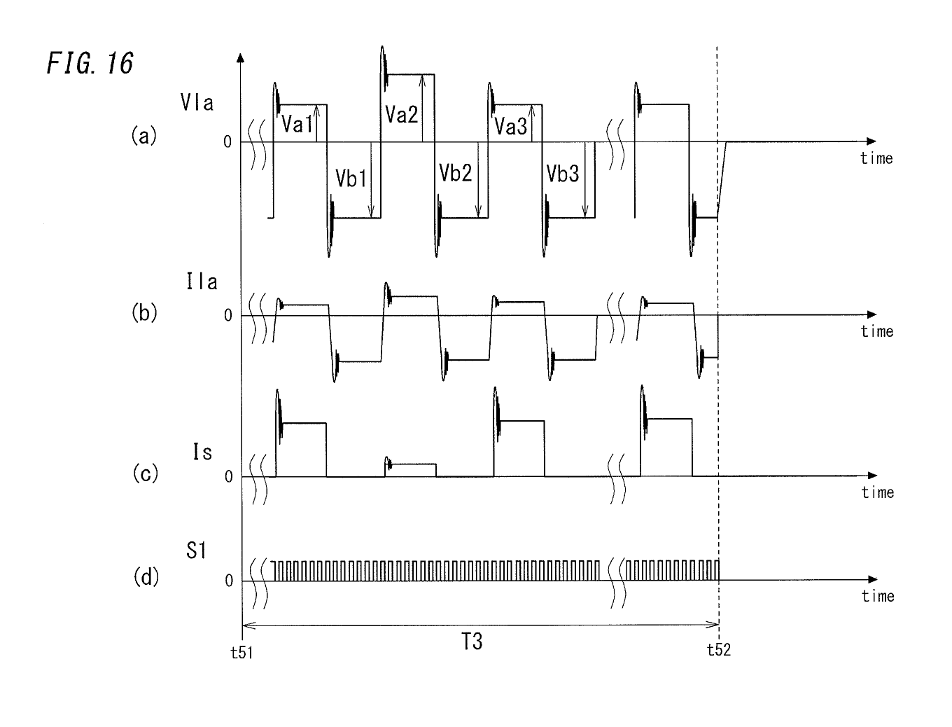

For example, as shown in FIG. 16 (a) to (d), when a ground fault occurs at the point X1, the discharge lamp La is not extinguished, and the lamp current Ila continues to flow, and additionally the ground fault current Is occurs. While this ground fault occurs, the absolute values Va and Vb of the lamp voltage Vla are likely to fluctuate (see FIG. 16 (a)).

For example, at a first timing, the absolute values Va and Vb have Va1 and Vb1 respectively, and Va1 is less than Vb1. At a second timing subsequent to the first timing, the absolute values Va and Vb have Va2 and Vb2 respectively, and Va2 is substantially equal to Vb2. At a third timing subsequent to the second timing, the absolute values Va and Vb have Va3 and Vb3 respectively, and Va3 is substantially equal to Vb3. At the first timing, the voltage proportion D has D1=Va1/Vb1>K1. At the second timing, the voltage proportion D has D2=Va2/Vb2<K1. At the third timing, the voltage proportion D has D3=Va3/Vb3>K1.

In this regard, for example, a judgment criterion for the occurrence of the abnormality is that a state where the voltage proportion D is not less than the threshold K1 has occurred over the predetermined period T1 continuously, and the predetermined period T1 is counted by use of a timer. In such a situation, when the voltage proportion D is changed from D1 to D2, there is a possibility that the counted time of the timer is reset.

In view of this, in the present embodiment, upon acknowledging that the number of times of an event where the voltage proportion D is not less than the threshold K1 or the number of times of an event where the voltage difference F is not less than the threshold K2 is equal to or more than the predetermined number of times before a passage of the predefined period T3, the current target calculation unit 7c of the controller 7 concludes that the abnormality has occurred.

For example, when the number of times of the event where the voltage proportion D is not less than the threshold K1 or the number of times of the event where the voltage difference F is not less than the threshold K2 is identical to N in the period T3 between time points t51 and t52 shown in FIG. 16, the current target calculation unit 7c concludes that the abnormality has occurred.

Hence, even in a situation where the lamp voltage Vla fluctuates due to occurrence of a ground fault, it is enabled to terminate the circuit operation.

As mentioned above, in the discharge lamp lighting device “A” of the present embodiment, when the number of times that the controller 7 detects a state where a difference not less than the threshold occurs between the voltage detection value of the first polarity and the voltage detection value of the second polarity becomes equal to or more than the predetermined number of times N before a passage of the predefined period T3, the controller 7 concludes that the abnormality has occurred.

In other words, the discharge lamp lighting device “A” of the present embodiment includes the following sixteenth feature in addition to the first feature. As for the sixteenth feature, the controller 7 is configured to, upon acknowledging that the number of times of occurrence of the asymmetric state becomes not less than (equal to or more than) the predetermined number of times N before a passage of the prescribed period T3, conclude that the asymmetric state has occurred over the predetermined period T1.

Note that, the discharge lamp lighting device “A” of the present embodiment may include one or more optional features selected from the aforementioned second to fourth and eighth to twelfth features. Further, the discharge lamp lighting device “A” of the present embodiment may include one or more optional features selected from the aforementioned thirteenth and fourteenth features, instead of the aforementioned third and fourth features. Furthermore, the discharge lamp lighting device “A” of the present embodiment may include the fifteenth feature, instead of the aforementioned tenth and eleventh features.

### Fifth Embodiment

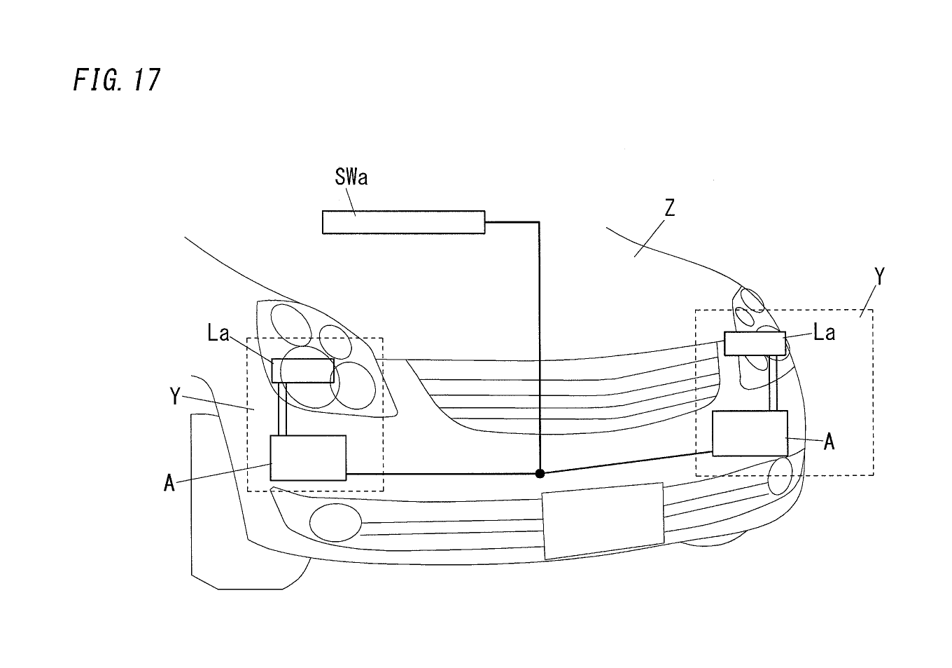

FIG. 17 is a schematic diagram illustrating a car “Z” employing the discharge lamp lighting device “A” according to any one of the first to fourth embodiments as an automotive high-intensity discharge lamp lighting device.

The discharge lamp lighting device “A” (automotive high-intensity discharge lamp lighting device) is mounted on the car “Z” such as an automobile, and is designed to light the high-intensity discharge lamp La serving as a headlight of the car “Z”.

That is, the automotive high-intensity discharge lamp lighting device in accordance with the present embodiment uses the discharge lamp lighting device “A” according to any one of the first to fourth embodiments to light the high-intensity discharge lamp (discharge lamp) La. In other words, the automotive high-intensity discharge lamp lighting device of the present embodiment is defined by the discharge lamp lighting device “A” employing the aforementioned first feature, and is configured to light the high-intensity discharge lamp La.

Moreover, the discharge lamp lighting device “A” and the high-intensity discharge lamp La which are mounted on the car “Z” constitute an automotive headlight device “Y”.

Namely, the automotive headlight device “Y” in accordance with the present embodiment includes the discharge lamp lighting device “A” according to any one of the first to fourth embodiments and the discharge lamp La lit by the discharge lamp lighting device “A”. In other words, the automotive headlight device “Y” in accordance with the present embodiment includes the discharge lamp La and the discharge lamp lighting device “A” involving the aforementioned first feature. The discharge lamp lighting device “A” is configured to light the discharge lamp La.

In the automotive high-intensity discharge lamp lighting device and the automotive headlight device “Y”, the discharge lamp lighting device “A” may include one or more optional features selected from the aforementioned second to twelfth features. Further, the discharge lamp lighting device “A” may include one or more optional features selected from the aforementioned thirteenth and fourteenth features, instead of the aforementioned third and fourth features. Furthermore, the discharge lamp lighting device “A” may include the fifteenth feature, instead of the aforementioned tenth and eleventh features. Moreover, the discharge lamp lighting device “A” may include the sixteenth feature, instead of the aforementioned fifth to seventh features.

Further, the car “Z” in accordance with the present embodiment includes the automotive headlight device “Y”.

In recent years, to secure a living space in an automobile and to save weight for improvement of a fuel efficiency, an engine room tends to be downsized and such downsizing is likely to cause an increase in a temperature in the engine room. Additionally, since the engine room is equipped with an engine having a high calorific value, the temperature in the engine room tends to be more increased.

The discharge lamp lighting device “A” used for the automotive headlight device “Y” is installed in this engine room, and is required to have a fail-safe function of terminating the circuit operation in response to the occurrence of the abnormality of the load for protection of the circuit. In brief, the discharge lamp lighting device “A” is required to have high robustness in a hot environment.

In view of this, with employing the discharge lamp lighting device “A” according to any one of the first to fourth embodiments, it is possible to successfully prevent circuit breakage which would otherwise occur due to thermal stress caused by the abnormality (e.g., a ground fault). Moreover, since the discharge lamp lighting device “A” can produce the above effect with a simplified circuit configuration, it is possible to downsize the discharge lamp lighting device “A”.

1. A discharge lamp lighting device comprising a controller configured to perform an abnormality judgment process of judging whether or not abnormality has occurred based on a measured value of a driving voltage defined as an AC voltage applied to a discharge lamp,
wherein:
the controller is configured to, in the abnormality judgment process, judge whether or not an asymmetric state in which the driving voltage lacks symmetry has occurred over a predetermined period; and
the controller is configured to, upon concluding that the asymmetric state has occurred over the predetermined period, conclude that the abnormality has occurred.

2. The discharge lamp lighting device as set forth in claim 1, wherein
the controller is configured to, upon acknowledging that an absolute value of one of a first measured value defined as the measured value obtained before a reversal of polarity of the driving voltage and a second measured value defined as the measured value obtained after the reversal of polarity of the driving voltage is greater than an absolute value of the other of the first measured value and the second measured value, conclude that the asymmetric state has occurred.

3. The discharge lamp lighting device as set forth in claim 2, wherein
the controller is configured to:
calculate a proportion of a larger one of the absolute values of the respective first and second measured values to a smaller one of the absolute values of the respective first and second measured values; and
upon acknowledging that the proportion is not less than a threshold, conclude that the asymmetric state has occurred.

4. The discharge lamp lighting device as set forth in claim 3, wherein
the threshold is not less than 1.5.

5. The discharge lamp lighting device as set forth in claim 2, wherein
the controller is configured to:
calculate a difference between the absolute values of the respective first and second measured values; and
upon acknowledging that an absolute value of the difference is not less than a threshold, conclude that the asymmetric state has occurred.

6. The discharge lamp lighting device as set forth in claim 5, wherein
the threshold is not less than one-half of a rated lamp voltage of the discharge lamp.

7. The discharge lamp lighting device as set forth in claim 1, wherein
the controller is configured to, upon acknowledging that the asymmetric state continues for the predetermined period, conclude that the asymmetric state has occurred over the predetermined period.

8. The discharge lamp lighting device as set forth in claim 7, wherein
the predetermined period has a length equal to that of a start-up period of the discharge lamp.

9. The discharge lamp lighting device as set forth in claim 7, wherein
the predetermined period has a length not less than 10 seconds.

10. The discharge lamp lighting device as set forth in claim 1, wherein
the controller is configured to, upon acknowledging that the number of times of occurrence of the asymmetric state is not less than a predetermined number of times before a passage of a prescribed period, conclude that the asymmetric state has occurred over the predetermined period.

11. The discharge lamp lighting device as set forth in claim 1, wherein
the discharge lamp lighting device further comprising a lighting circuit unit having a function of applying an AC voltage to the discharge lamp, and
the controller is configured to control the lighting circuit unit to adjust power supplied to the discharge lamp.

12. The discharge lamp lighting device as set forth in claim 11, wherein
the lighting circuit unit comprises:
a power converter configured to generate DC power by use of power from an external power source;
an inverter configured to apply an AC voltage to the discharge lamp by use of the DC power generated by the power converter;
a voltage detector configured to measure a voltage applied to the discharge lamp; and
a current detector configured to measure a current flowing through the discharge lamp,
the controller is configured to adjust the DC power generated by the power converter based on a measured value of the voltage detector and a measured value of the current detector.

13. The discharge lamp lighting device as set forth in claim 11, wherein
the controller is configured to, upon concluding that the abnormality has occurred, decrease power supplied to the discharge lamp down to a predetermined value.

14. The discharge lamp lighting device as set forth in claim 13, wherein
the controller is configured to gradually decrease power supplied to the discharge lamp.

15. The discharge lamp lighting device as set forth in claim 11, wherein
the lighting circuit unit has a function of applying a DC voltage to the discharge lamp, and
the controller is configured to, upon concluding that the abnormality has occurred, control the lighting circuit unit in such a manner to supply to the discharge lamp a DC voltage having the same polarity as that corresponding to larger one of the absolute values of the respective first and second measured values.

16. The discharge lamp lighting device as set forth in claim 1, wherein
the controller is configured to start the abnormality judgment process after the discharge lamp is changed from a state in the start-up period to a state in a steady lighting period.

17. An automotive high-intensity discharge lamp lighting device defined by the discharge lamp lighting device according to claim 1, and configured to light a high-intensity discharge lamp.

18. An automotive headlight device comprising:
a discharge lamp; and
the discharge lamp lighting device according to claim 1,
wherein the discharge lamp lighting device is configured to light the discharge lamp.

19. A car comprising the automotive headlight device according to claim 18.
